(19) United States
(12) Patent Application Publication
(10) Pub. No.: US 2023/0239951 A1
(43) Pub. Date: Jul. 27, 2023

(54) METHOD AND DEVICE FOR WIRELESS COMMUNICATION

(71) Applicants: Yu CHEN, SHANGHAI (CN); Xiaobo ZHANG, SHANGHAI (CN)

(72) Inventors: Yu CHEN, SHANGHAI (CN); Xiaobo ZHANG, SHANGHAI (CN)

(73) Assignee: SHANGHAI LANGBO COMMUNICATION TECHNOLOGY COMPANY LIMITED, SHANGHAI (CN)

(21) Appl. No.: 18/098,725

(22) Filed: Jan. 19, 2023

(30) Foreign Application Priority Data
Jan. 24, 2022 (CN) 202210078084.5

(51) Int. Cl. H04W 76/18; H04W 76/19

(52) U.S. Cl. CPC H04W 76/18; H04W 76/19

(57) ABSTRACT

The present application provides a method and device for wireless communications, comprising receiving a first signaling, the first signaling being used to configure a first bearer and a second bearer, and both the first bearer and the second bearer being associated with a first cell group; the first cell group is an MCG; detecting a target bearer failure; as a response to the behavior of detecting a target bearer failure, executing a first operation set; the first operation set is related to whether the target bearer is the first bearer or the second bearer; the present application helps to optimize the network, improve the reliability of communications and avoid communications interruption by detecting the target bearing failure and executing the first operation set.

### CROSS REFERENCE TO RELATED APPLICATIONS

This application claims the priority benefit of Chinese Patent Application No. 202210078084.5, filed on Jan. 24, 2022, the full disclosure of which is incorporated herein by reference.

### BACKGROUND

### Technical Field

The present application relates to transmission methods and devices in wireless communication systems, and in particular to a method and device for network optimization, service quality improvement, relay communications and other aspects of communications.

### Related Art

Application scenarios of future wireless communication systems are becoming increasingly diversified, and different application scenarios have different performance demands on systems. In order to meet different performance requirements of various application scenarios, 3rd Generation Partner Project (3GPP) Radio Access Network (RAN) #72 plenary decided to conduct the study of New Radio (NR), or what is called fifth Generation (5G). A work Item (WI) of NR was approved at 3GPP RAN #75 plenary to standardize the NR.

In communications, whether Long Term Evolution (LTE) or 5G NR involves features of accurate reception of reliable information, optimized energy efficiency ratio, determination of information efficiency, flexible resource allocation, scalable system structure, efficient non-access layer information processing, low service interruption and dropping rate and support for low power consumption, which are of great significance to the maintenance of normal communications between a base station and a UE, reasonable scheduling of resources and balancing of system payload. Those features can be called the cornerstone of high throughout and are characterized in meeting communication requirements of various service, improving spectrum utilization and improving service quality, which are indispensable in enhanced Mobile BroadBand (eMBB), Ultra Reliable Low Latency Communications (URLLC) and enhanced Machine Type Communications (eMTC). Meanwhile, in the following communication modes, covering Industrial Internet of Things (IIoT), Vehicular to X (V2X), Device to Device communications, Unlicensed Spectrum communications, User communication quality monitoring, network planning optimization, Non-Territorial Networks (NTN), Territorial Networks (TN), and Dual connectivity system, there are extensive requirements in radio resource management and selection of multi-antenna codebooks as well as in signaling design, adjacent cell management, service management and beamforming. Transmission methods of information are divided into broadcast transmission and unicast transmission, both of which are essential for 5G system for that they are very helpful to meet the above requirements. The UE can be connected to the network directly or through a relay.

With the increase of scenarios and complexity of systems, higher requirements are raised for interruption rate and time delay reduction, reliability and system stability enhancement, service flexibility and power saving. At the same time, compatibility between different versions of different systems should be considered when designing the systems.

3GPP standardization organization has done relevant standardization work for 5G and formed a series of standards. The standard contents can be referred to:

https://www.3gpp.org/ftp/Specs/archive/38_series/38.211/38211-g60.zip

https://www.3gpp.org/ftp/Specs/archive/38_series/38.213/38213-g60.zip

https://www.3gpp.org/ftp/Specs/archive/38_series/38.331/38331-g60.zip SUMMARY

In various communication scenarios, the use of relay will be involved, for example, when a User Equipment (UE) is at the edge of the cell and the coverage is poor, it can access the network through a relay, which can be another UE. The relay mainly comprises a Layer-3 relay and a Layer-2 relay (L2 U2N relay), both of which provide network access services for a remote node (U2N remote UE) through the relay node, where the Layer-3 relay is transparent to RAN, that is, the remote UE only establishes a connection with the core network, and the RAN cannot identify whether data is from the remote node or the relay node; while the Layer-2 relay, the remote node (U2N remote UE) and the RAN have an RRC connection, the RAN can manage the remote node, and a radio bearer can be established between the RAN and the remote node. The relay can be another UE, in a system supporting the Layer-2 relay, the UE can communicate with the network through the L2 U2N relay UE, that is, using an indirect path, or directly communicate with the network not through the relay, that is, using a direct path. In some scenarios, a UE can use both a direct path and an indirect path to acquire better reliability and higher throughput. The direct path and the indirect path are different in radio resource management and network optimization. One of the direct path and the indirect path does not use a relay and the other uses a relay, and the relay node may provide services for multiple nodes. Therefore, the throughput, QoS, and functions of the two paths may be different. In some scenarios, the indirect path and the direct path cannot replace each other. Therefore, when a failure occurs in the direct path and the indirect path, the processing methods of the two should also be different, otherwise different characteristics of the two cannot be taken into account, which may lead to the failure of network communications. For example, since the indirect path cannot provide complete functions, such as only providing some functions of the user interface, and when the direct path fails, only relying on the indirect path cannot ensure normal communications. For UE connected to the network through multiple paths, how to take appropriate measures against the failure occurring in different paths is the problem to be solved in the present application. Of course, the solution proposed in the present application can also solve other problems in the communication system, but not limited to the above problems.

To address the above problem, the present application provides a solution.

It should be noted that if no conflict is incurred, embodiments in any node in the present application and the characteristics of the embodiments are also applicable to any other node, and vice versa. And the embodiments in the present application and the characteristics in the embodiments can be arbitrarily combined if there is no conflict.

The present application provides a method in a first node for wireless communications, comprising:

receiving a first signaling, the first signaling being used to configure a first bearer and a second bearer, both the first bearer and the second bearer being associated with a first cell group; the first cell group is a Master Cell Group (MCG); detecting a target bearer failure; and

as a response to the behavior of detecting a target bearer failure, executing a first operation set; the first operation set is related to whether the target bearer is the first bearer or the second bearer;

herein, the second bearer is associated with a first relay, and the first relay is an L2 U2N relay UE; the meaning of the phrase of the first operation set being related to whether the target bearer is the first bearer or the second bearer is: when the target bearer is the first bearer, the first operation set comprises at least a former of transmitting an RRC message and receiving an RRC message, and the first operation set comprises at least one of cell selection or relay selection; when the target bearer is the second bearer, the first operation set comprises transmitting first information, and the first information is used to indicate the target bearer failure.

In one embodiment, a problem to be solved in the present application comprises: in the scenario where L2 relay is used, especially when direct path and indirect path are used at the same time, corresponding measures shall be taken for the failure occurring in different paths, so as to ensure reliable and stable communications.

In one embodiment, advantages of the above method comprise: when using the L2 relay is supported, especially using multiple paths to communicate with the network at the same time is supported, when a failure occurs in one of the paths, the normal operation of network communications can be ensured as much as possible, rapid recovery can be carried out, resuming delay and communication interruption can be reduced, service quality can be improved, coverage can be expanded, so as to better support mobility and business continuity.

Specifically, according to one aspect of the present application, SRB1 of the first node is only associated with the first bearer in the first bearer and the second bearer.

Specifically, according to one aspect of the present application, SRB1 of the first node is associated with the first bearer and the second bearer at the same time.

Specifically, according to one aspect of the present application, the first operation set comprises: releasing the second bearer, suspending SRB1 associated with the target bearer; the first operation set comprises: executing any of cell selection and relay selection;

herein, the first operation set comprises transmitting an RRC re-establishment request message.

Specifically, according to one aspect of the present application, the first operation set comprises: executing at least one operation in a second operation set only for a former of the first bearer and the second bearer;

herein, the second operation set comprises suspending, re-establishing, and releasing.

Specifically, according to one aspect of the present application, whether the first operation set comprises initiating a random access is related to whether the target bearer is the first bearer or the second bearer; when the target bearer is the first bearer, the first operation set comprises initiating a random access procedure; when the target bearer is the second bearer, the first operation set does not comprise initiating a random access procedure.

Specifically, according to one aspect of the present application, a second signaling is received, as a response to receiving the second signaling, a first timer is started;

herein, when the behavior of detecting that a target bearer failure is executed, the first timer is running; the second signaling comprises a first field, the first field is reconfigurationWithSync, the first field is used to indicate a path switch for the second bearer, and the target bearer is the first bearer; the first timer is a timer other than T304.

Specifically, according to one aspect of the present application, as a response to receiving a second sub-signaling, a first timer is started, a third bearer is suspended, and the second bearer is configured;

herein, the first operation set comprises: activating the third bearer; the first operation set comprises at least one of suspending the second bearer, releasing the second bearer or re-establishing the second bearer; the first signaling comprises a first sub-signaling, the second sub-signaling and a third sub-signaling, the first sub-signaling is used to configure the first bearer, the third sub-signaling is used to configure the third bearer, and the second sub-signaling is used to configure the second bearer; the third bearer is associated with a second relay, the second relay is an L2 U2N relay UE, the first relay is different from the second relay, and the third bearer is associated with the first cell group; the target bearer is the second bearer; the second sub-signaling comprises a first field, the first field is reconfigurationWithSync, the first field is used to indicate a path switch for the third bearer, and the first timer is a timer other than T304; the behavior of detecting a target bearer failure comprises detecting an expiration of the first timer.

Specifically, according to one aspect of the present application, a third signaling is received, and the third signaling is used to indicate a path switch for the target bearer;

herein, the first operation set comprises: executing the third signaling; a reception of the third signaling is earlier than the behavior of detecting the target bearer failure.

Specifically, according to one aspect of the present application, a fourth signaling is received, and the fourth signaling is used to configure a fourth bearer; the behavior of configuring the fourth bearer comprises setting the fourth bearer as a deactivated state;

herein, the first operation set comprises: activating the fourth bearer; the first operation set comprises: at least one of suspending the second bearer, deactivating the second bearer or releasing the second bearer; the target bearer is the second bearer.

Specifically, according to one aspect of the present application, the first node is an IoT terminal.

Specifically, according to one aspect of the present application, the first node is a relay.

Specifically, according to one aspect of the present application, the first node is a U2N remote UE.

Specifically, according to one aspect of the present application, the first node is a vehicle terminal.

Specifically, according to one aspect of the present application, the first node is an aircraft.

Specifically, according to one aspect of the present application, the first node is a mobile phone.

Specifically, according to one aspect of the present application, the first node is a communication terminal supporting multi-SIM card communications.

The present application provides a first node for wireless communications, comprising:

a first receiver, receiving a first signaling, the first signaling being used to configure a first bearer and a second bearer, both the first bearer and the second bearer being associated with a first cell group; the first cell group is an MCG; detecting a target bearer failure;

a first processor, as a response to the behavior of detecting a target bearer failure, executing a first operation set; the first operation set is related to whether the target bearer is the first bearer or the second bearer.

herein, the second bearer is associated with a first relay, and the first relay is an L2 U2N relay UE; the meaning of the phrase of the first operation set being related to whether the target bearer is the first bearer or the second bearer is: when the target bearer is the first bearer, the first operation set comprises at least a former of transmitting an RRC message and receiving an RRC message, and the first operation set comprises at least one of cell selection or relay selection; when the target bearer is the second bearer, the first operation set comprises transmitting first information, and the first information is used to indicate the target bearer failure.

In one embodiment, the present application has the following advantages over conventional schemes:

support for the relay, especially the processing comprising resuming in case of bearer failure when L2 U2N relay UE is used.

when both direct and indirect paths are configured, support for the processing based on the failure on one of the two paths, in particular, if one of the bearers or paths fails while the other does not, ensuring normal communications without interference.

support for the network to configure and process the direct path and the indirect path differently, that is, making distinguish in functions, which is conducive to simplifying the processing in case of failure, and can increase the throughput. At the same time, when the indirect path does not have all functions, for example, when the indirect path is only used to transmit user-plane data, the indirect path can stop, start, activate, deactivate, release more quickly and flexibly without affecting the signaling transmission between the remote node and the network, that is, the control plane is not affected.

when a path, such as an indirect path, fails, it can quickly be switched between multiple candidate paths by suspending, activating, and other means, thus ensuring the service continuity.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of receiving a first signaling, detecting a target bearer failure and executing a first operation set according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of radio signal transmission according to one embodiment of the present application;

FIG. 6 illustrates a flowchart of a radio signal transmission according to one embodiment of the present application;

FIG. 7 illustrates a schematic diagram of a protocol stack for relay communications according to one embodiment of the present application;

FIG. 8 illustrates a schematic diagram of a topology according to one embodiment of the present application;

FIG. 9 illustrates a schematic diagram of first information being used to indicate a target bearer failure according to one embodiment of the present application;

FIG. 10 illustrates a schematic diagram of a first field being used to indicate a path switch for a second bearer according to one embodiment of the present application;

FIG. 11 illustrates a schematic diagram of a first field being used to indicate a path switch for a third bearer according to one embodiment of the present application;

FIG. 12 illustrates a schematic diagram of a third signaling being used to indicate a path switch for a target bearer according to one embodiment of the present application;

FIG. 13 illustrates a schematic diagram of a processor in a first node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

Embodiment 1 illustrates a flowchart of receiving a first signaling, detecting a target bearer failure and executing a first operation set according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, the first node in the present application receives a first signaling in step 101, detects a target bearer failure in step 102, and executes a first operation set in step 103;

herein, the first signaling is used to configure a first bearer and a second bearer, both the first bearer and the second bearer are associated with a first cell group; the first cell group is an MCG;

the first node, as a response to the behavior of detecting a target bearer failure, executes a first operation set; the first operation set is related to whether the target bearer is the first bearer or the second bearer.

the second bearer is associated with a first relay, and the first relay is an L2 U2N relay UE; the meaning of the phrase of the first operation set being related to whether the target bearer is the first bearer or the second bearer is: when the target bearer is the first bearer, the first operation set comprises at least a former of transmitting an RRC message and receiving an RRC message, and the first operation set comprises at least one of cell selection or relay selection; when the target bearer is the second bearer, the first operation set comprises transmitting first information, and the first information is used to indicate the target bearer failure.

In one embodiment, the first node is a User Equipment (UE).

In one embodiment, the first node is in an RRC_CONNECTED state.

In one embodiment, the direct path refers to a transmission path from the UE to the network, and a transmission through the direct path means that data transmitted between the U2N remote UE and the network is not through a relay.

In one subembodiment of the above embodiment, the data comprises higher-layer data and a signaling.

In one subembodiment of the above embodiment, the data comprises an RRC signaling.

In one subembodiment of the above embodiment, the data comprises a bit string or a bit block.

In one subembodiment of the above embodiment, the data only comprises a signaling or data carried by a radio bearer (RB).

In one embodiment, the indirect path refers to a transmission path from the UE to the network, and a transmission through the indirect path means that data is forwarded between the U2N remote UE and the network through the U2N relay UE.

In one subembodiment of the above embodiment, the data comprises higher-layer data and a signaling.

In one subembodiment of the above embodiment, the data comprises an RRC signaling.

In one subembodiment of the above embodiment, the data comprises a bit string or a bit block.

In one subembodiment of the above embodiment, the data only comprises a signaling or data carried by a radio bearer (RB).

In one embodiment, a radio link is either the direct path or an indirect path.

In one embodiment, a U2N relay UE refers to a UE providing the functionality of supporting a connectivity of a U2N remote UE to the network.

In one embodiment, a U2N remote UE refers to a UE that needs to be through a U2N relay UE to communicate with the network.

In one embodiment, a U2N remote UE refers to a UE that needs to be through a U2N relay UE to communicate with the network.

In one embodiment, a U2N remote UE refers to a UE in communications with the network and supporting relay services.

In one embodiment, a U2N relay is a U2N relay UE.

In one embodiment, when transmitting and receiving unicast services with the network, both a U2N relay and a U2N remote node are in an RRC_CONNECTED state.

In one embodiment, a U2N remote UE is in an RRC_IDLE state or an RRC_INACTIVE state, and a U2N relay UE can be in any RRC state, comprising an RRC_CONNECTED state, an RRC_IDLE state and an RRC_INACTIVE state.

In one embodiment, a transmission not through a direct path is equal to a transmission through an indirect path.

In one embodiment, a transmission not through a direct path comprises a transmission through a relay.

In one embodiment, a transmission through a direct path is or comprises a transmission not through a relay.

In one embodiment, a transmission through a direct path is or comprises forwarding not through a relay.

In one embodiment, a U2N relay UE is a UE providing a functionality of supporting a connectivity to the network for a U2N remote UE.

In one subembodiment of the embodiment, a U2N relay UE is a UE.

In one subembodiment of the embodiment, a U2N relay UE provides relay services to the network for a U2N remote UE.

In one embodiment, a U2N remote UE is a UE that is in communications with the network through a U2N relay UE.

In one embodiment, a direct mode is a mode using the direct path.

In one embodiment, the direct mode is a mode in which a U2N remote UE uses the direct path to communicate with the network.

In one embodiment, the direct mode is a mode of transmitting an RRC signaling or establishing an RRC connection between a U2N remote UE using the direct path and the network.

In one embodiment, an indirect mode is a mode using the indirect path.

In one embodiment, the indirect mode is a mode using the indirect path.

In one embodiment, the direct mode is a mode in which a U2N remote UE uses the indirect path to be in communications with the network.

In one embodiment, the direct mode is a mode of transmitting an RRC signaling or establishing an RRC connection between a U2N remote UE using the indirect path and the network.

In one embodiment, a serving cell is or comprises a UE-camped cell. Executing a cell search comprises: a UE searches for a suitable cell of a selected Public Land Mobile Network (PLMN) or a Stand-alone Non-Public Network (SNPN), selects the suitable cell to provide available services, and monitors a control channel of the suitable cell, and this procedure is defined as camping on a cell; that is, a camped cell is a serving cell of the UE relative to the UE. Advantages of camping on a cell in an RRC_IDLE state or an RRC_INACTIVE state are: enabling the UE to receive a system message from the PLMN or the SNPN; after registration, if the UE wishes to establish an RRC connection or continue a suspended RRC connection, the UE can achieve this by executing an initial access on a control channel of a camping cell; the network may page the UE; so that the UE can receive notifications of Earthquake and Tsunami Warning System (ETWS) and Commercial Mobile Alert System (CMAS).

In one embodiment, for a U2N remote node, a serving cell is or comprises a cell camped or connected by a U2N relay.

In one embodiment, for a UE in an RRC_CONNECTED state that is not configured with carrier aggregation/dual connectivity (CA/DC), only one serving cell comprises a PCell. For a UE in an RRC_CONNECTED state that is configured with CA/DC, a serving cell is used to indicate a cell set comprising a Special Cell (SpCell) and all Secondary Cells (SCells). The PCell is an MCG cell, which works on primary frequency, and the UE executes an initial connection establishment procedure or initiates a connection re-establishment on the PCell. For a dual connectivity operation, an SpCell refers to a PCell of an MCG or a Primary SCG Cell (PSCell) of an SCG; if it is not a dual connectivity operation, an SpCell refers to a PCell.

In one embodiment, a frequency on which a Secondary Cell (SCell) operates is a sub-frequency.

In one embodiment, an individual content of an information element is called a field.

In one embodiment, a Multi-Radio Dual Connectivity (MR-DC) refers to a dual connectivity between an E-UTRA and an NR node, or a dual connectivity between two NR nodes.

In one embodiment, in a MR-DC, a radio access node providing a control-plane connectivity to the core network is a master node, the master node may be a master eNB, a master ng-eNB, or a master gNB.

In one embodiment, an MCG refers to, in an MR-DC, a group of serving cells associated with a master node, comprising an SpCell, and also optionally one or multiple SCells.

In one embodiment, a PCell is an SpCell of an MCG.

In one embodiment, a PSCell is an SpCell of an SCG.

In one embodiment, in an MR-DC, a control-plane connectivity to the core network is not provided, and a radio access node providing extra resources to the UE is a sub-node. The sub-node can be an en-gNB, a sub-ng-eNB or a sub-gNB.

In one embodiment, in an MR-DC, a group of serving cells associated with a sub-node is a Secondary Cell Group (SCG), comprising an SpCell and, optionally, one or multiple SCells.

In one embodiment, an access-layer functionality that enables Vehicle-to-Everything (V2X) communications defined in 3GPP standard TS 23. 285 is V2X sidelink communications, where the V2X sub-link communications occur between adjacent UEs and uses E-UTRA technology but does not traverse the network node.

In one embodiment, at least an access-layer functionality that enables V2X communications defined in 3GPP standard TS 23.287 is NR sidelink communications, where the NR sidelink communications occur between two or multiple adjacent UEs, and use NR technology but do not traverse the network node.

In one embodiment, the sidelink is a direct communication link between UE-to-UE, using a sidelink resource allocation mode, a physical-layer signal or a channel, and a physical-layer procedure.

In one embodiment, not being or not at or not being located within is equal to being outside coverage.

In one embodiment, within coverage is equal to being within coverage.

In one embodiment, outside the coverage is equal to being out of coverage.

In one embodiment, the first node is a U2N remote node.

In one embodiment, PDCP entities corresponding to a radio bearer between a UE and the network are respectively located within the UE and the network.

In one embodiment, the direct path is a communication link or a channel or a bearer used during the direct path transmission.

In one embodiment, the direct path transmission refers to data carried by at least an SRB between the UE and the network is not relayed or forwarded through other nodes.

In one embodiment, the direct path transmission refers to that an RLC bearer associated with at least a Signaling radio bearer (SRB) between a UE and the network respectively terminates at the UE and the network.

In one embodiment, the direct path transmission refers to an RLC entity associated with at least an SRB between a UE and the network respectively terminates at the UE and the network.

In one embodiment, the direct path transmission refers to that there exists a direct communication link between a UE and the network.

In one embodiment, the direct path transmission refers to that there exists a Uu interface between a UE and the network.

In one embodiment, the direct path transmission refers to that there exists a MAC layer of a Uu interface between a UE and the network, and the MAC layer of the Uu interface carries an RRC layer.

In one embodiment, the direct path transmission refers to that there exists a physical layer of a Uu interface between a UE and the network.

In one embodiment, the direct path transmission refers to that there exists a logical channel and/or transport channel between a UE and the network.

In one embodiment, the indirect path is an indirect path or a communication link or a channel or a bearer used during the indirect path transmission.

In one embodiment, the indirect path transmission refers to that data carried by at least an SRB between a UE and the network is relayed or forwarded through other nodes.

In one embodiment, the indirect path transmission refers to an RLC bearer associated with at least an SRB between a UE and the network respectively terminates at the UE and other nodes as well as other nodes and the network.

In one embodiment, the indirect path transmission refers to an RLC entity associated with at least an SRB between a UE and the network respectively terminates at the UE and other nodes as well as other nodes and the network.

In one embodiment, the phrase of the meaning of at least an SRB comprises at least one of SRB0, SRB1, SRB2 or SRB3.

In one embodiment, the phrase of the meaning of at least an SRB comprises an SRB and a Data Radio Bearer (DRB).

In one embodiment, the indirect path transmission refers to that there does not exist a direct communication link between a UE and the network.

In one embodiment, the indirect path transmission refers to that there does not exist a MAC layer of a Uu interface between a UE and the network.

In one embodiment, the indirect path transmission refers to that there does not exist a physical layer of a Uu interface between a UE and the network.

In one embodiment, the indirect path transmission refers to that there does not exist a logical channel nor a transport channel between a UE and the network.

In one embodiment, the network comprises RAN and/or a serving cell and/or a base station.

In one embodiment, the UE in the phrase of a UE and the network comprises the first node.

In one embodiment, the other nodes comprise a relay node or other UEs.

In one embodiment, when using a direct path transmission, a UE transmits a physical-layer signaling to the network. when using an indirect path transmission, a UE cannot transmit or directly transmit a physical-layer signaling to the network.

In one embodiment, when using a direct path transmission, a UE transmits a MAC CE to the network; when using an indirect path transmission, a UE cannot transmit or directly transmit a MAC CE to the network.

In one embodiment, when using a direct path transmission, there does not exist other protocol layers between a PDCP layer and an RLC layer of the first node; when using an indirect path transmission, there exists other protocol layers between a PDCP layer and an RLC layer of the first node.

In one subembodiment of the embodiment, the other protocols are or comprise an adaptation layer.

In one embodiment, when using a transmission of a direct path, the network directly schedules an uplink transmission of the first node through a DCI; when using an indirect path transmission, the network directly schedules an uplink transmission of the first node not through a DCI.

In one embodiment, when a direct path transmission is used, an SRB of the first node is associated with an RLC entity and/or an RLC layer and/or an RLC bearer; when an indirect path transmission is used, an SRB of the first node is associated with an RLC entity of a PC5 interface.

In one embodiment, when a direct path transmission is used, there exists a mapping relation between an SRB of the first node and an RLC entity of a Uu interface; when an indirect path transmission is used, there exists a mapping relation between an SRB of the first node and an RLC entity of a PC5 interface.

In one embodiment, there exists a direct path and/or indirect path between the first node and the network.

In one embodiment, the meaning of switching from a direct path to an indirect path is: starting using an indirect path, and stopping using a direct path at the same time.

In one embodiment, the meaning of switching from a direct path to an indirect path is: starting using an indirect path transmission, and stopping using a direct path transmission.

In one embodiment, the meaning of switching from a direct path to an indirect path is: switching from a direct path transmission to an indirect path transmission.

In one embodiment, the meaning of switching from a direct path to an indirect path is: the first node associates an SRB with an RLC entity of a PC5 interface, and releasing an RLC entity of a Uu interface associated with the SRB at the same time.

In one embodiment, the meaning of switching from a direct path to an indirect path is: the first node associates an SRB and a DRB with an RLC entity of a PC5 interface, and releases an RLC entity of a Uu interface associated with the SRB and the DRB at the same time.

In one embodiment, the meaning of switching from an indirect path to a direct path is: starting using a direct path transmission, and stopping using an indirect path transmission.

In one embodiment, the meaning of switching from an indirect path to a direct path is: starting using a direct path transmission, and stopping using an indirect path transmission at the same time.

In one embodiment, the meaning of switching from an indirect path to a direct path is: switching from an indirect path transmission to a direct path transmission.

In one embodiment, the meaning of switching from an indirect path to a direct path is: the first node releases an RLC entity of a PC5 interface associated with an SRB, and associated with an SRB with an RLC entity of a Uu interface.

In one embodiment, the meaning of switching from an indirect path to a direct path is: the first node releases all RLC entities of a PC5 interface associated with a DRB, and associated with a DRB with an RLC entity of a Uu interface.

In one embodiment, the first node supports a transition from an indirect path to an indirect path.

In one embodiment, when the first node uses an indirect path, a relay used in the indirect path is a first relay.

In one embodiment, a relay in the present application is a U2N relay UE.

In one embodiment, the first node is in an RRC_CONNECTED state.

In one embodiment, the first node in the present application does not use a dual connectivity (DC).

In one embodiment, the first node in the present application is not configured with a DC.

In one embodiment, the first node in the present application only has one cell group.

In one embodiment, the first node in the present application only has one cell group, that is, an MCG.

In one embodiment, the first node in the present application is not configured with an SCG.

In one embodiment, a relay in the present application refers to an L2 U2N relay UE.

In one embodiment, the first node in the present application uses a direct part and an indirect path at the same time.

In one embodiment, the first bearer is a direct path; the second bearer is an indirect path.

In one embodiment, both the first bearer and the second bearer are indirect paths.

In one embodiment, the first bearer is an RLC bearer; the second bearer is a PC5 RLC bearer.

In one embodiment, the first bearer is a Uu RLC bearer; the second bearer is a PC5 RLC bearer.

In one embodiment, the first bearer is a main link radio link; the second bearer is a sidelink radio link.

In one embodiment, the first bearer is a DRB; the second bearer is an MRB.

In one embodiment, the first bearer is an SRB; the second bearer is a DRB.

In one embodiment, the first bearer is an SRB; the second bearer is an MRB.

In one embodiment, the first bearer is an MRB; the second bearer is a DRB or an SRB.

In one embodiment, the first bearer is a radio link between the first node and the first cell group; the second relay is a sidelink radio link between the first node and the first relay as well as the first relay is an L2 U2N relay UE between the first node and the first cell group.

In one embodiment, both the first bearer and the second bearer are bearers of an AS layer.

In one embodiment, one of the first bearer and the second bearer is an AS layer bearer, and the other one is a NAS layer bearer.

In one subembodiment of the above embodiment, the first bearer is an AS-layer bearer, and the second bearer is an NAS-layer bearer.

In one subembodiment of the above embodiment, the second bearer is an AS-layer bearer, and the first bearer is an NAS-layer bearer.

In one embodiment, the first bearer is a channel of main link, and the second bearer is a channel of sidelink.

In one subembodiment of the above embodiment, the main link is a non-relayed radio link between the first node and a first cell group or a base station of the first cell group.

In one embodiment, the first bearer is a physical channel of main link, and the second bearer is a physical channel of sidelink.

In one subembodiment of the above embodiment, the main link is a non-relayed radio link between the first node and the first cell group or a base station of a first cell group.

In one embodiment, the first bearer is a transport channel of main link, and the second bearer is a transport channel of sidelink.

In one subembodiment of the above embodiment, the main link is a non-relayed link between the first node and the first cell group or a base station of a first cell group.

In one embodiment, the first bearer is a logical channel of main link, and the second bearer is a logical channel of sidelink.

In one subembodiment of the above embodiment, the main link is a non-relayed radio link between the first node and the first cell group or a base station of a first cell group.

In one embodiment, the second bearer comprises a sidelink radio link between the first node and the first relay and a radio link between the first relay and the first cell group.

In one embodiment, the second bearer comprises a sidelink RLC bearer between the first node and the first relay and an RLC bearer between the first relay and the first cell group.

In one embodiment, the second bearer comprises a channel between the first node and the first relay and a channel between the first relay and the first cell group.

In one embodiment, the second bearer comprises a bearer between the first node and the first relay and a bearer between the first relay and the first cell group.

In one embodiment, the target bearer is a direct path.

In one embodiment, the target bearer is an indirect path.

In one embodiment, the target bearer is a radio bearer.

In one embodiment, the target bearer is an RLC bearer.

In one embodiment, the target bearer is a sidelink RLC bearer.

In one embodiment, the target bearer is a unicast bearer.

In one embodiment, the target bearer is a broadcast or multicart or groupcast bearer.

In one embodiment, the target bearer is a radio link.

In one embodiment, the target bearer is a sidelink.

In one embodiment, the target bearer is a communication link.

In one embodiment, the target bearer is a channel.

In one embodiment, the target bearer is a network channel.

In one embodiment, the target bearer belongs to an AS layer.

In one embodiment, the target bearer is a radio link between the first node and the first cell group.

In one embodiment, the target bearer is a sidelink radio link between the first node and the first relay, the target bearer is associated with at least one of a DRB or an SRB or an MRB of the first node, and the DRB or the SRB or the MRB of the first node is a radio bearer between the first node and the first cell group.

In one embodiment, the target bearer is a sidelink radio link between the first node and the first relay, and the target bearer is used to transmit a PDCP PDU for the first cell group.

In one embodiment, the target bearer is a direct link between the first node and the first relay, and the direct link is used to transmit data between the first node and the first cell group.

In one embodiment, the target bearer is a direct unicast link between the first node and the first relay, and the direct unicast link is used to transmit data between the first node and the first cell group.

In one embodiment, the phrase of the target bearer failure refers to that the target bearer has a radio link failure.

In one embodiment, the phrase of the target bearer failure refers to that the target bearer has a sidelink radio link failure.

In one embodiment, the phrase of the target bearer failure refers to that the target bearer has a failure.

In one embodiment, the phrase of the target bearer failure refers to that the target bearer has an unrecoverable failure.

In one embodiment, the phrase of the target bearer failure refers to that the target bearer cannot continue be used.

In one embodiment, the phrase of the target bearer failure refers to that the target bearer must be released or suspended.

In one embodiment, the phrase of the target bearer failure refers to a link to which the target bearer belongs fails.

In one embodiment, the phrase of the target bearer failure refers to that the target bearer is failed or illegal.

In one embodiment, the phrase of the target bearer failure refers to need to stop using the target bearer.

In one embodiment, the phrase of the target bearer failure refers to need to stop transmitting data on the target bearer.

In one embodiment, the phrase of the target bearer failure refers to need to stop receiving data on the target bearer.

In one embodiment, the phrase of the target bearer failure refers to need to stop transmitting data on the target bearer, but can continue receiving data on the target bearer.

In one embodiment, the phrase of the target bearer failure refers to need to release a direct unicast link related to the target bearer.

In one embodiment, the first cell group is an MCG.

In one embodiment, the first cell group only comprises a PCell.

In one embodiment, the first cell group comprises a PCell and at least one SCell.

In one embodiment, the meaning of the phrase of both the first bearer and the second bearer being associated with the first cell group is: the first bearer is associated with the first cell group, and the second bearer is associated with the first cell group.

In one embodiment, the meaning of the phrase of the first bearer being associated with the first cell group is: the first bearer is a bearer between the first node and the first cell group.

In one embodiment, the meaning of the phrase of the first bearer being associated with the first cell group is: the first bearer terminates at the first node and the first cell group.

In one embodiment, the meaning of the phrase of the first bearer being associated with the first cell group is: the first bearer terminates at the first node and a base station of the first cell group.

In one embodiment, the meaning of the phrase of the first bearer being associated with the first cell group is: PDCP entities corresponding to the first bearer are respectively at the first node and the first cell group.

In one embodiment, the meaning of the phrase of the first bearer being associated with the first cell group is: RLC entities corresponding to the first bearer are respectively at the first node and the first cell group.

In one embodiment, the meaning of the phrase of the first bearer being associated with the first cell group is: a MAC corresponding to or used by or mapped by the first bearer is for the first cell group.

In one embodiment, the meaning of the phrase of the first bearer being associated with the first cell group is: the first bearer is used to transmit a PDCP PDU between the first node and the first cell group.

In one embodiment, the meaning of the phrase of the first bearer being associated with the first cell group is: the first bearer is used to transmit a PDCP SDU between the first node and the first cell group.

In one embodiment, the meaning of the phrase of the first bearer being associated with the first cell group is: the first bearer is used to transmit an RLC PDU between the first node and the first cell group.

In one embodiment, the meaning of the phrase of the first bearer being associated with the first cell group is: the first bearer is used to transmit a MAC PDU between the first node and the first cell group.

In one embodiment, the meaning of the phrase of the first bearer being associated with the first cell group is: the first bearer is used to transmit data between the first cell group.

In one embodiment, the meaning of the phrase of the first bearer being associated with the first cell group is: at least SRB1 between the first node and the first cell group uses the first bearer.

In one embodiment, the meaning of the phrase of the first bearer being associated with the first cell group is: there exists a mapping relation between at least SRB1 between the first node and the first cell group as well as the first bearer.

In one embodiment, the meaning of the phrase of the first bearer being associated with the first cell group is: the first bearer is a bearer between the first node and the first relay, and the first relay is a relay between the first node and the first cell group.

In one embodiment, the meaning of the phrase of the first bearer being associated with the first cell group is: the first bearer is a bearer between the first node and the first relay, and the first relay forwards data between the first node and the first cell group.

In one embodiment, the meaning of the phrase of the first bearer being associated with the first cell group is: the first bearer is an RLC bearer between the first node and the first relay, and the first relay is a relay between the first node and the first cell group.

In one embodiment, the meaning of the phrase of the first bearer being associated with the first cell group is: the first bearer is an RLC bearer between the first node and the first relay, and the first relay forwards data between the first node and the first cell group.

In one embodiment, the meaning of the phrase of the first bearer being associated with the first cell group is: the first bearer is a sidelink radio link between the first node and the first relay, and the first relay is a relay between the first node and the first cell group.

In one embodiment, the meaning of the phrase of the first bearer being associated with the first cell group is: the first bearer is a sidelink radio link between the first node and the first relay, and the first relay forwards data between the first node and the first cell group.

In one embodiment, the meaning of the phrase of the first bearer being associated with the first cell group is: the first bearer is an RLC bearer between the first node and the first relay, the first bearer is used to bear at least SRB1, and the at least SRB1 is an SRB between the first node and the first cell group.

In one embodiment, the meaning of the phrase of the second bearer being associated with the first cell group is: the second bearer is a bearer between the first node and the first cell group.

In one embodiment, the meaning of the phrase of the second bearer being associated with the first cell group is: the second bearer terminates at the first node and the first cell group.

In one embodiment, the meaning of the phrase of the second bearer being associated with the first cell group is: the second bearer terminates at the first node and a base station of the first cell group.

In one embodiment, the meaning of the phrase of the second bearer being associated with the first cell group is: PDCP entities corresponding to the second bearer are respectively at the first node and the first cell group.

In one embodiment, the meaning of the phrase of the second bearer being associated with the first cell group is: RLC entities corresponding to the second bearer are respectively at the first node and the first cell group.

In one embodiment, the meaning of the phrase of the second bearer being associated with the first cell group is: a MAC corresponding to or used by or mapped by the second bearer is for the first cell group.

In one embodiment, the meaning of the phrase of the second bearer being associated with the first cell group is: the second bearer is used to transmit a PDCP PDU between the first node and the first cell group.

In one embodiment, the meaning of the phrase of the second bearer being associated with the first cell group is: the second bearer is used to transmit a PDCP SDU between the first node and the first cell group.

In one embodiment, the meaning of the phrase of the second bearer being associated with the first cell group is: the second bearer is used to transmit an RLC PDU between the first node and the first cell group.

In one embodiment, the meaning of the phrase of the second bearer being associated with the first cell group is: the second bearer is used to transmit a MAC PDU between the first node and the first cell group.

In one embodiment, the meaning of the phrase of the second bearer being associated with the first cell group is: the second bearer is used to transmit data between the first cell group.

In one embodiment, the meaning of the phrase of the second bearer being associated with the first cell group is: at least SRB1 between the first node and the first cell group uses the second bearer.

In one embodiment, the meaning of the phrase of the second bearer being associated with the first cell group is: there exists a mapping relation between at least SRB1 between the first node and the first cell group and the second bearer.

In one embodiment, the meaning of the phrase of the second bearer being associated with the first cell group is: the second bearer is a bearer between the first node and the first relay, and the first relay is a relay between the first node and the first cell group.

In one embodiment, the meaning of the phrase of the second bearer being associated with the first cell group is: the second bearer is a bearer between the first node and the first relay, and the first relay forwards data between the first node and the first cell group.

In one embodiment, the meaning of the phrase of the second bearer being associated with the first cell group is: the second bearer is an RLC bearer between the first node and the first relay, and the first relay is a relay between the first node and the first cell group.

In one embodiment, the meaning of the phrase of the second bearer being associated with the first cell group is: the second bearer is an RLC bearer between the first node and the first relay, and the first relay forwards data between the first node and the first cell group.

In one embodiment, the meaning of the phrase of the second bearer being associated with the first cell group is: the second bearer is a sidelink radio link between the first node and the first relay, and the first relay is a relay between the first node and the first cell group.

In one embodiment, the meaning of the phrase of the second bearer being associated with the first cell group is: the second bearer is a sidelink radio link between the first node and the first relay, and the first relay forwards data between the first node and the first cell group.

In one embodiment, the meaning of the phrase of the second bearer being associated with the first cell group is: the second bearer is an RLC bearer between the first node and the first relay, the second bearer is used to bear at least SRB1, and the at least SRB1 is an SRB between the first node and the first cell group.

In one embodiment, the first operation set comprises at least one operation.

In one embodiment, an RLC entity associated with the target bearer refers to: the target bearer is an RLC bearer, and an RLC entity associated with the target bearer is an RLC entity corresponding to the RLC bearer.

In one embodiment, an RLC entity associated with the target bearer refers to: the target bearer is a sidelink RLC bearer, and an RLC entity associated with the target bearer is an RLC entity of a PC5 interface corresponding to the sidelink RLC bearer.

In one embodiment, an RLC entity associated with the target bearer refers to: the target bearer is a radio bearer, and an RLC entity associated with the target bearer is an RLC entity corresponding to an RLC bearer used to bear the target bearer.

In one embodiment, an RLC entity associated with the target bearer refers to: the target bearer is a radio bearer, and an RLC entity associated with the target bearer is an RLC entity of a PC5 interface corresponding to a sidelink RLC bearer used to bear the target bearer.

In one embodiment, an RLC entity associated with the target bearer refers to: the target bearer is a physical channel, and an RLC entity associated with the target bearer is an RLC entity generating an RLC PDU carried by the target bearer.

In one embodiment, an RLC entity associated with the target bearer refers to: the target bearer is a transport channel, and an RLC entity associated with the target bearer is an RLC entity generating an RLC PDU carried by the target bearer.

In one embodiment, an RLC entity associated with the target bearer refers to: the target bearer is a logical channel, and an RLC entity associated with the target bearer is an RLC entity corresponding to the target bearer.

In one embodiment, an RLC entity associated with the target bearer refers to: the target bearer is a sidelink physical channel, and an RLC entity associated with the target bearer is an RLC entity generating an RLC PDU carried by the target bearer.

In one embodiment, an RLC entity associated with the target bearer refers to: the target bearer is a sidelink transport channel, and an RLC entity associated with the target bearer is an RLC entity generating an RLC PDU carried by the target bearer.

In one embodiment, an RLC entity associated with the target bearer refers to: the target bearer is a sidelink logical channel, and an RLC entity associated with the target bearer is an RLC entity corresponding to the target bearer.

In one embodiment, an RLC entity associated with the target bearer refers to: the target radio bearer is a radio link for the first cell group, and an RLC entity associated with the target bearer is an RLC entity generating an RLC PDU transmitted by the target bearer.

In one embodiment, an RLC entity associated with the target bearer refers to: the target bearer is a sidelink radio link for an L2 U2N relay UE, the L2 U2N relay UE is an L2 U2N relay UE between the first node and the first cell group, and an RLC entity associated with the target bearer is an RLC entity that generates an RLC PDU transmitted by the target bearer used to bear a PDCP PDU for the first cell group.

In one embodiment, an RLC entity associated with the target bearer comprises an RLC entity of a Uu interface.

In one embodiment, an RLC entity associated with the target bearer comprises an RLC entity of a PC5 interface.

In one embodiment, an RLC entity associated with the target bearer is an RLC entity with a mapping relation with the target bearer.

In one embodiment, an RLC entity associated with target bearer is an RLC entity that encapsulates data on the target bearer.

In one embodiment, an RLC entity associated with target bearer is an RLC entity that generates data carried by the target bearer.

In one embodiment, as a response to the behavior of detecting a target bearer failure, the first node records information related to the target bearer failure in a first state variant.

In one embodiment, the first state variant is a start variant of the first node.

In one embodiment, a name of the first state variant comprises “var”.

In one embodiment, a name of the first state variant comprises “report”.

In one embodiment, a name of the first state variant comprises “relay”.

In one embodiment, a name of the first state variant comprises “path”.

In one embodiment, a name of the first state variant comprises “relay”.

In one embodiment, the first state variant is VarRLF-Report.

In one embodiment, the first information is transmitted through an RRC message.

In one embodiment, the first information is transmitted through a MAC CE.

In one embodiment, when the target bearer is the first-type bearer, the first information is transmitted through a MAC CE; when the target bearer is the second-type bearer, the first information is transmitted through an RRC message;

In one embodiment, the behavior of storing information for the target bearer failure in the first state variant comprises: storing an identity of the first cell group.

In one embodiment, the behavior of storing information for the target bearer failure in the first state variant comprises: storing an identity of a PCell of the first cell group.

In one embodiment, the behavior of storing information for the target bearer failure in the first state variant comprises: storing a cause of the target bearer failure.

In one embodiment, the behavior of storing information for the target bearer failure in the first state variant comprises: storing a type of the target bearer failure.

In one embodiment, the behavior of storing information for the target bearer failure in the first state variant comprises: storing whether a second bearer is used.

In one embodiment, the behavior of storing information for the target bearer failure in the first state variant comprises: storing a measurement result.

In one embodiment, the behavior of storing information for the target bearer failure in the first state variant comprises: storing a measurement result of a configured measured object.

In one embodiment, the behavior of storing information for the target bearer failure in the first state variant comprises: storing an identity of a used L2 U2N relay UE.

In one embodiment, an RLC entity associated with the first bearer refers to: the first bearer is an RLC bearer, and an RLC entity associated with the first bearer is an RLC entity corresponding to the RLC bearer.

In one embodiment, an RLC entity associated with the first bearer refers to: the first bearer is a sidelink RLC bearer, and an RLC entity associated with the first bearer is an RLC entity of a PC5 interface corresponding to the sidelink RLC bearer.

In one embodiment, an RLC entity associated with the first bearer refers to: the first bearer is a radio bearer, and an RLC entity associated with the first bearer is an RLC entity corresponding to an RLC bearer used to bear the first bearer.

In one embodiment, an RLC entity associated with the first bearer refers to: the first bearer is a radio bearer, and an RLC entity associated with the first bearer is an RLC entity of a PC5 interface corresponding to a sidelink RLC bearer used to bear the first bearer.

In one embodiment, an RLC entity associated with the first bearer refers to: the first bearer is aphysical channel, and an RLC entity associated with the first bearer is an RLC entity generating an RLC PDU carried by the first bearer.

In one embodiment, an RLC entity associated with the first bearer refers to: the first bearer is a transport channel, and an RLC entity associated with the first bearer is an RLC entity generating an RLC PDU carried by the first bearer.

In one embodiment, an RLC entity associated with the first bearer refers to: the first bearer is a logical channel, and an RLC entity associated with the first bearer is an RLC entity corresponding to the first bearer.

In one embodiment, an RLC entity associated with the first bearer refers to: the first bearer is a sidelink physical channel, and an RLC entity associated with the first bearer is an RLC entity generating an RLC PDU carried by the first bearer.

In one embodiment, an RLC entity associated with the first bearer refers to: the first bearer is a sidelink transport channel, and an RLC entity associated with the first bearer is an RLC entity generating an RLC PDU carried by the first bearer.

In one embodiment, an RLC entity associated with the first bearer refers to: the first bearer is a sidelink logical channel, and an RLC entity associated with the first bearer is an RLC entity corresponding to the first bearer.

In one embodiment, an RLC entity associated with the first bearer refers to: the first radio bearer is a radio link for the first cell group, and an RLC entity associated with the first bearer is an RLC entity generating an RLC PDU transmitted by the first bearer.

In one embodiment, an RLC entity associated with the first bearer refers to: the first bearer is a sidelink radio link for the first relay, the first relay is an L2 U2N relay UE between the first node and the first cell group, and an RLC entity associated with the first bearer is an RLC entity that generates an RLC PDU for a PDCP PDU for the first cell group transmitted by the first bearer.

In one embodiment, an RLC entity associated with the first bearer is an RLC entity with a mapping relation with the first bearer.

In one embodiment, an RLC entity associated with first bearer is an RLC entity that encapsulates data on the first bearer.

In one embodiment, an RLC entity associated with the first bearer is an RLC entity generating data carried by the first bearer.

In one embodiment, an RLC entity associated with the second bearer refers to: the second bearer is an RLC bearer, and an RLC entity associated with the second bearer is an RLC entity corresponding to the RLC bearer.

In one embodiment, an RLC entity associated with the second bearer refers to: the second bearer is a sidelink RLC bearer, and an RLC entity associated with the second bearer is an RLC entity of a PC5 interface corresponding to the sidelink RLC bearer.

In one embodiment, an RLC entity associated with the second bearer refers to: the second bearer is a radio bearer, and an RLC entity associated with the second bearer is an RLC entity corresponding to an RLC bearer used to bear the second bearer.

In one embodiment, an RLC entity associated with the second bearer refers to: the second bearer is a radio bearer, and an RLC entity associated with the second bearer is an RLC entity of a PC5 interface corresponding to a sidelink RLC bearer used to bear the second bearer.

In one embodiment, an RLC entity associated with the second bearer refers to: the second bearer is a physical channel, and an RLC entity associated with the second bearer is an RLC entity generating an RLC PDU carried by the second bearer.

In one embodiment, an RLC entity associated with the second bearer refers to: the second bearer is a transport channel, and an RLC entity associated with the second bearer is an RLC entity generating an RLC PDU carried by the second bearer.

In one embodiment, an RLC entity associated with the second bearer refers to: the second bearer is a logical channel, and an RLC entity associated with the second bearer is an RLC entity corresponding to the second bearer.

In one embodiment, an RLC entity associated with the second bearer refers to: the second bearer is a sidelink physical channel, and an RLC entity associated with the second bearer is an RLC entity generating an RLC PDU carried by the second bearer.

In one embodiment, an RLC entity associated with the second bearer refers to: the second bearer is a sidelink transport channel, and an RLC entity associated with the second bearer is an RLC entity generating an RLC PDU carried by the second bearer.

In one embodiment, an RLC entity associated with the second bearer refers to: the second bearer is a sidelink logical channel, and an RLC entity associated with the second bearer is an RLC entity corresponding to the second bearer.

In one embodiment, an RLC entity associated with the second bearer refers to: the second bearer is a radio link for the first cell group, and an RLC entity associated with the second bearer is an RLC entity generating an RLC PDU transmitted by the second bearer.

In one embodiment, an RLC entity associated with the second bearer refers to: the second bearer is a sidelink radio link for an L2 U2N relay UE, the L2 U2N relay UE is an L2 U2N relay UE between the first node and the first cell group, and an RLC entity associated with the second bearer is an RLC entity that generates an RLC PDU transmitted by the second bearer used for bearing a PDCP PDU for the first cell group.

In one embodiment, an RLC entity associated with the second bearer is an RLC entity with a mapping relation with the second bearer.

In one embodiment, an RLC entity associated with second bearer is an RLC entity that encapsulates data on the second bearer.

In one embodiment, an RLC entity associated with the second bearer is an RLC entity generating data carried by the second bearer.

In one embodiment, an RRC message comprising the first message uses the second bearer for a transmission.

In one embodiment, the first bearer is different from the second bearer.

In one embodiment, a peer RLC entity of an RLC entity of the Uu interface is located at the first cell group or a base station corresponding to the first cell.

In one embodiment, a peer RLC entity of an RLC entity of the PC5 interface is located at the first relay.

In one embodiment, an RLC entity of the PC5 interface is for sidelink communications.

In one embodiment, an RLC entity of the Uu interface is for non-sidelink communications or main link communications.

In one embodiment, the first bearer uses main link.

In one embodiment, the second bearer uses sidelink.

In one embodiment, the meaning of the phrase of the first bearer using a main link is: the first bearer is a main link.

In one embodiment, the meaning of the phrase of the first bearer using a main link is: the first bearer is a main link radio link.

In one embodiment, the meaning of the phrase of the first bearer using a main link is: the first bearer is a direct path.

In one embodiment, the meaning of the phrase of the first bearer using a main link is: the first bearer is a bearer between the first node and the first cell group and is not through any relay.

In one embodiment, the meaning of the phrase of the first bearer using a main link is: the first bearer corresponds to a Uu interface.

In one embodiment, the meaning of the phrase of the first bearer using a main link is: a physical channel corresponding to or associated with the first bearer is a physical channel of a Uu interface.

In one embodiment, the meaning of the phrase of the first bearer using a main link is: a physical channel corresponding to or associated with or used by the first bearer comprises a physical uplink control channel (PUCCH) and a physical downlink control channel (PDCCH).

In one embodiment, the meaning of the phrase of the first bearer using a main link is: the first bearer is an RLC bearer, and an RLC entity corresponding to the RLC bearer is located at the first node and the first cell group.

In one embodiment, the meaning of the phrase of the first bearer using a main link is: a protocol entity corresponding to the first bearer is located at the first node and the first cell group.

In one embodiment, the meaning of the phrase of the first bearer using a main link is: the first bearer is a channel, and the target bearer is a channel between the first node and the first cell group.

In one embodiment, the meaning of the phrase of the first bearer using a main link is: a channel corresponding to the first bearer is a channel between the first node and the first cell group.

In one embodiment, the meaning of the phrase of the second bearer using sidelink is: the second bearer is sidelink.

In one embodiment, the meaning of the phrase of the second bearer using sidelink is: the second bearer is a sidelink radio link.

In one embodiment, the meaning of the phrase of the second bearer using sidelink is: the second bearer is an indirect path.

In one embodiment, the meaning of the phrase of the second bearer using sidelink is: the second bearer is a bearer through L2 U2N relay UE between the first node and the first cell group.

In one embodiment, the meaning of the phrase of the second bearer using sidelink is: the second bearer corresponds to a PC5 interface.

In one embodiment, the meaning of the phrase of the second bearer using sidelink is: a physical channel corresponding to or associated with the second bearer is a physical channel of a PC5 interface.

In one embodiment, the meaning of the phrase of the second bearer using sidelink is: a physical channel corresponding to or associated with or used by the second bearer comprises a physical sidelink shared channel (PSSCH) and a physical sidelink control channel (PSCCH).

In one embodiment, the meaning of the phrase of the second bearer using sidelink is: the second bearer is a sidelink RLC bearer, and an RLC entity corresponding to the RLC bearer is located at the first node and an L2 U2N relay UE.

In one embodiment, the meaning of the phrase of the second bearer using sidelink is: a protocol entity corresponding to the second bearer is located at the first node and an L2 U2N relay UE.

In one embodiment, the meaning of the phrase of the second bearer using sidelink is: the second bearer is a channel, and the target bearer is a channel between the first node and an L2 U2N relay UE.

In one embodiment, the meaning of the phrase of the second bearer using sidelink is: a channel corresponding to the second bearer is a channel between the first node and an L2 U2N relay UE.

In one embodiment, the meaning of the phrase of the first relay being an L2 U2N relay UE is: the first bearer belongs to a type of UE such as L2 U2N relay UE.

In one embodiment, the first node is only configured with a cell group.

In one embodiment, the first node is only configured with an MCG without configuring with an SCG.

In one embodiment, the first bearer is an RLC bearer, and the second bearer is a sidelink RLC bearer.

In one embodiment, the first operation set comprises resetting a MAC associated with the target bearer.

In one embodiment, a MAC being associated with the target bearer is: a MAC with a mapping relation with the target bearer.

In one embodiment, a MAC being associated with the target bearer is: a MAC bearing data of the target bearer.

In one embodiment, a MAC being associated with the target bearer is: a MAC of a PDU bearing the target bearer.

In one embodiment, a MAC being associated with the target bearer is: the target bearer is a physical channel, and a MAC generating a MAC PDU carried by the target bearer is a MAC associated with the target bearer.

In one embodiment, a MAC being associated with the target bearer is: a MAC generating a MAC PDU occupying the target bearer is a MAC associated with the target bearer.

In one embodiment, a MAC being associated with the target bearer is: a MAC of main link or a Uu interface.

In one embodiment, a MAC associated with the second bearer is: a MAC of sidelink or a PC5 interface.

In one embodiment, the behavior of resetting a MAC being associated with the target bearer is resetting a MAC associated with the target bearer.

In one embodiment, the target bearer is only associated with a MAC.

In one embodiment, a MAC being associated with the target bearer is different from a MAC associated with the second bearer.

In one embodiment, a MAC associated with the first bearer is different from a MAC associated with the second bearer.

In one embodiment, a MAC associated with the first bearer is the same as a MAC associated with the second bearer.

In one embodiment, the behavior of detecting a target bearer failure comprises: detecting that T310 timer is expired.

In one embodiment, the behavior of detecting a target bearer failure comprises: detecting that T310 timer associated with the target bearer is expired.

In one embodiment, the behavior of detecting a target bearer failure comprises: detecting that T312 timer is expired.

In one embodiment, the behavior of detecting a target bearer failure comprises: detecting that T312 timer associated with the target bearer is expired.

In one embodiment, the behavior of detecting a target bearer failure comprises: detecting that T304 timer is expired.

In one embodiment, the behavior of detecting a target bearer failure comprises: detecting that T304 timer associated with the target bearer is expired.

In one embodiment, the behavior of detecting a target bearer failure comprises: detecting that a first timer is expired, and the first timer is used for a path switch.

In one subembodiment of the embodiment, as a response to receiving a Reconfiguration with SYNC used for a path switch, the first timer is started.

In one embodiment, the behavior of detecting a target bearer failure comprises: detecting that a first timer associated with the target bearer is expired, and the first timer is used for a path switch.

In one subembodiment of the embodiment, as a response to receiving a Reconfiguration with SYNC used for a path switch, the first timer is started.

In one embodiment, the behavior of detecting a target bearer failure comprises: detecting a radio link failure, and the target bearer is the first bearer.

In one embodiment, the behavior of detecting a target bearer failure comprises: detecting a sidelink radio link failure, and the target bearer is the second bearer.

In one embodiment, the behavior of detecting a target bearer failure comprises: detecting a sidelink RRC configuration incompatibility, and the target bearer is the second bearer.

In one embodiment, the behavior of detecting a target bearer failure comprises: detecting that T400 timer is expired, and the target bearer is the second bearer.

In one embodiment, the behavior of detecting a target bearer failure comprises: receiving an indication of reaching a maximum number of Hybrid Automatic Repeat Request (HARQ) discontinuous transmission (DTX) from a MAC, the target bearer is the second bearer.

In one embodiment, the behavior of detecting a target bearer failure comprises: detecting an indication of a higher layer, and indicating that the target bearer is released or unavailable or failed.

In one embodiment, the behavior of detecting a target bearer failure comprises: detecting a security failure.

In one embodiment, the behavior of detecting a target bearer failure comprises: receiving a first notification, the first notification is used to determine the target bearer failure, and the target bearer is the second bearer.

In one subembodiment of the embodiment, a transmitter of the first notification is an L2 U2N relay UE of the first node.

In one subembodiment of the embodiment, the first notification is transmitted on sidelink.

In one subembodiment of the embodiment, the first notification is NotificationMessageSidelink.

In one subembodiment of the embodiment, the first notification indicates that a radio link failure occurs in an L2 U2N relay UE of the first node.

In one subembodiment of the embodiment, the first notification indicates that an L2 U2N relay UE of the first node receives an RRCreconfiguration message of ReconfigurationWithSync.

In one subembodiment of the embodiment, the first notification indicates that an L2 U2N relay UE of the first node receives an RRCreconfiguration message of ReconfigurationWithSync related to an MCG.

In one subembodiment of the embodiment, the first notification indicates that a cell reselection occurs in an L2 U2N relay UE of the first node.

In one embodiment, the behavior of detecting a target bearer failure comprises: an indication related to random access problems is received from a MAC, and the target bearer is the first bearer.

In one embodiment, the behavior of detecting a target bearer failure comprises: receiving an indication from an RLC entity of reaching a maximum number of retransmissions, the target bearer is the first bearer.

In one subembodiment of the embodiment, the RLC entity indicating reaching a maximum number of retransmissions is an RLC entity associated with the target bearer or corresponding to the target bearer.

In one embodiment, the behavior of detecting a target bearer failure comprises: receiving an indication from a MAC related to continuous listen before talk (LBT) failure problems, the target bearer is the first bearer.

In one embodiment, the first node is not configured with an SRB3.

In one embodiment, when the target bearer is the first bearer, and the first operation set comprises initiating an RRC re-establishment; when the target bearer is the second bearer, the first operation set comprises initiating an RRC re-establishment.

In one embodiment, the target bearer is the first bearer, the first operation set comprises dropping a stored RRC message segmentation; when the target bearer is the second bearer, the first operation set does not comprise dropping a stored RRC message segmentation.

In one embodiment, when the target bearer is the first bearer, the behavior of detecting the target bearer failure will trigger an RRC re-establishment; when the target bearer is the second bearer, the behavior of detecting the target bearer failure will not trigger executing an RRC re-establishment.

In one embodiment, when the target bearer is the first bearer, the first operation set comprises re-establishing an RLC entity associated with the target bearer; when the target bearer is the second bearer, the first operation set does not comprise re-establishing an RLC entity associated with the target bearer.

In one embodiment, the behavior of re-establishing an RLC entity associated with the target bearer comprises: dropping all RLC SDUs, RLC SDU segmentations and RLC PDUs.

In one embodiment, the behavior of re-establishing an RLC entity associated with the target bearer comprises: stopping and resetting all timers of an RLC entity associated with the target bearer.

In one embodiment, the behavior of re-establishing an RLC entity associated with the target bearer comprises: resetting uninitialized values of all state variants of an RLC entity associated with the target bearer.

In one embodiment, the meaning of the phrase of the second bearer being associated with a first relay is: a protocol entity corresponding to the second bearer is located at the first node and the first relay.

In one embodiment, the meaning of the phrase of the second bearer being associated with a first relay is: the second bearer is a bearer between the first node and the first relay.

In one embodiment, the meaning of the phrase of the second bearer being associated with a first relay is: the second bearer is a radio link between the first node and the first relay.

In one embodiment, the meaning of the phrase of the second bearer being associated with a first relay is: the second bearer is a sidelink RLC bearer between the first node and the first relay.

In one embodiment, the meaning of the phrase of the second bearer being associated with a first relay is: the second bearer is a sidelink radio link between the first node and the first relay.

In one embodiment, the meaning of the phrase of the second bearer being associated with a first relay is: the second bearer is a channel between the first node and the first relay.

In one embodiment, the meaning of the phrase of the second bearer being associated with a first relay is: a receiver of data on the second bearer is the first relay.

In one embodiment, the meaning of the phrase of the second bearer being associated with a first relay is: data on the second bearer is forwarded by the first relay.

In one embodiment, the meaning of the phrase of the second bearer being associated with a first relay is: data on the second bearer occupies resources of the first relay.

In one embodiment, the meaning of the phrase of the second bearer being associated with a first relay is: the second bearer uses a relay, and the used relay is the first relay.

In one embodiment, the meaning of the phrase of the second bearer being associated with a first relay is: the second bearer is an indirect path, and a relay involved by the indirect path is the first relay.

In one embodiment, the first signaling uses the first bearer for a transmission.

In one embodiment, the first signaling uses the second bearer to for a transmission.

In one embodiment, the first signaling is an RRC signaling.

In one embodiment, the first signaling comprises SIB12.

In one embodiment, the first signaling comprises an RRCReconfiguration.

In one embodiment, the first signaling comprises areconfigurationWithSync.

In one embodiment, the first signaling comprises cellgroupconfig.

In one embodiment, the first signaling comprises a masterCellGroup.

In one embodiment, the first signaling does not comprise a secondaryCellGroup.

In one embodiment, the meaning of the phrase of the first operation set comprising at least a former of transmitting an RRC message and receiving an RRC message comprises: the first operation set comprises transmitting an RRC message and does not comprise receiving an RRC message.

In one embodiment, the meaning of the phrase of the first operation set comprising at least a former of transmitting an RRC message and receiving an RRC message comprises: the first operation set comprises transmitting an RRC message and also comprises receiving an RRC message.

In one embodiment, the meaning of the phrase of the first operation set comprising at least a former of transmitting an RRC message and receiving an RRC message comprises: the first operation set does not comprise transmitting an RRC message and comprises receiving an RRC message.

In one embodiment, the meaning of the phrase of the first operation set comprising at least a former of transmitting an RRC message and receiving an RRC message comprises: the first operation set comprises at least transmitting an RRC message.

In one embodiment, the meaning of the phrase of the first operation set comprising at least one of cell selection or relay selection comprises: the first operation set comprises cell selection and does not comprise relay selection.

In one embodiment, the meaning of the phrase of the first operation set comprising at least one of cell selection or relay selection comprises: the first operation set does not comprise cell selection and also comprises relay selection.

In one embodiment, the meaning of the phrase of the first operation set comprising at least one of cell selection or relay selection comprises: the first operation set comprises cell selection and also comprises relay selection.

In one embodiment, the meaning of the phrase of the first operation set comprising at least one of cell selection or relay selection comprises: the first operation set comprises any of cell selection and relay selection.

In one subembodiment of the above embodiment, when the first node finds an appropriate cell then selects the appropriate cell; when the first node finds an appropriate relay then selects the appropriate relay; when the first node finds an appropriate cell and also finds an appropriate relay, then the first node selects the appropriate cell or the appropriate relay according to implementation.

In one embodiment, SRB1 of the first node is associated with the first bearer and the second bearer at the same time.

In one subembodiment of the above embodiment, SRB1 of the first node has a mapping relation with both the first bearer and the second bearer.

In one subembodiment of the above embodiment, data of the SRB1 uses any of the first bearer or the second bearer for a transmission.

In one subembodiment of the above embodiment, data of the SRB1 uses the first bearer and the second bearer for a transmission at the same time.

In one subembodiment of the above embodiment, the first bearer is an RLC bearer, the second bearer is a sidelink RLC bearer, and both the first bearer and the second bearer map with SRB1 of the first node.

In one subembodiment of the above embodiment, the first bearer is an RLC bearer, the second bearer is a sidelink RLC bearer, and an RB carried by the first bearer comprises SRB1 of the first node; an RB carried by the second bearer comprises SRB1 of the first node.

In one embodiment, the SRB1 of the first node is an SRB between the first node and the first cell group.

In one embodiment, SRB1 of the first node is only associated with the first bearer in the first bearer and the second bearer.

In one subembodiment of the above embodiment, SRB1 of the first node is associated with the first bearer, and the SRB1 of the first node is not associated with the second bearer.

In one subembodiment of the above embodiment, an RB carried by the first bearer comprises SRB1; an RB carried by the second bearer does not comprise the SRB1.

In one subembodiment of the above embodiment, there exists a mapping relation between the first bearer and SRB1 of the first node; there does not exist a mapping relation between the second bearer and SRB1 of the first node.

In one subembodiment of the above embodiment, data carried by the first bearer comprises data of the SRB1; data carried by the second bearer only comprises data of an SRB other than the SRB1.

In one embodiment, the first operation set comprises: executing at least one operation in a second operation set only for a former of the first bearer and the second bearer;

herein, the second operation set comprises suspending, re-establishing, and releasing.

In one subembodiment of the above embodiment, the first operation set comprises executing the second operation set for the first bearer.

In one subembodiment of the above embodiment, the first operation set does not comprise executing the second operation set for the second bearer.

In one subembodiment of the above embodiment, an operation executed for the second bearer comprised the first operation set does not comprise any operation in the second operation set.

In one subembodiment of the above embodiment, the first node executes suspending only for the first bearer in the first bearer and the second bearer.

In one subembodiment of the above embodiment, the first node executes re-establishment only for the first bearer in the first bearer and the second bearer.

In one subembodiment of the above embodiment, the first node executes releasing only for the first bearer in the first bearer and the second bearer.

In one embodiment, as a response to the behavior of detecting a target bearer failure, the first node only suspends the first bearer without suspending or re-establishing or releasing the second bearer.

In one embodiment, as a response to the behavior of detecting a target bearer failure, the first node only re-establishes the first bearer without suspending or re-establishing or releasing the second bearer.

In one embodiment, as a response to the behavior of detecting a target bearer failure, the first node only releases the first bearer without suspending or re-establishing or releasing the second bearer.

In one embodiment, as a response to the behavior of detecting a target bearer failure, the first node maintains the second bearer.

In one embodiment, the first signaling comprises a configuration of the first bearer.

In one embodiment, the first signaling indicates an RB mapped by the first bearer.

In one embodiment, the first signaling comprises a logical channel identity corresponding to the first bearer.

In one embodiment, the first signaling comprises a configuration of an RLC entity corresponding to the first bearer.

In one embodiment, the first signaling comprises a configuration of a PDCP entity corresponding to the first bearer.

In one embodiment, the first signaling comprises a configuration of a physical layer corresponding to the first bearer, for example, a reference signal used by a physical layer.

In one embodiment, the first signaling comprises a configuration of a channel corresponding to the first bearer.

In one embodiment, the first signaling comprises a configuration of the second bearer.

In one embodiment, the first signaling indicates an RB mapped by the second bearer.

In one embodiment, the first signaling comprises a logical channel identity corresponding to the second bearer.

In one embodiment, the first signaling comprises a configuration of an RLC entity corresponds to the second bearer.

In one embodiment, the first signaling comprises a configuration of a PDCP entity corresponds to the second bearer.

In one embodiment, the first signaling comprises configuration parameters of a physical layer corresponding to the second bearer, for example, a reference signal used by a physical layer.

In one embodiment, the first signaling comprises configuration parameters of a channel corresponding to the second bearer.

In one embodiment, the first signaling comprises an identity of the first relay.

In one embodiment, the first signaling comprises a measurement configuration for the first bearer and/or a second bearer.

Typically: when a failure in the target bearer is detected, a failure is detected in only the target bearer in the second bearer and the second bearer.

In one embodiment, when a failure is detected in the target bearer, a failure is detected in only the target bearer in the first bearer and the second bearer, and one of the first bearer and the second bearer other than the target bearer is in a recovering procedure.

In one embodiment, when a failure is detected in the target bearer, a failure is detected in only the target bearer in the first bearer and the second bearer, a T304 timer associated with one of the first bearer and the second bearer other than the target bearer is running.

In one embodiment, when a failure is detected in the target bearer, a failure is detected in only the target bearer in the first bearer and the second bearer, a T304 timer associated with one of the first bearer and the second bearer other than the target bearer is not running.

In one embodiment, when a failure is detected in the target bearer, a failure is detected in only the target bearer in the first bearer and the second bearer, a timer related to path switch associated with one of the first bearer and the second bearer other than the target bearer is not running.

In one embodiment, when a failure is detected in the target bearer, a failure is detected in only the target bearer in the first bearer and the second bearer, a timer related to path switch associated with one of the first bearer and the second bearer other than the target bearer is running.

In one embodiment, when a failure is detected in the target bearer, a failure is detected in only the target bearer in the first bearer and the second bearer, a timer related to path switch associated with one of the first bearer and the second bearer other than the target bearer is not running and T304 timer is not running.

In one embodiment, the first node is not configured with an SCG.

In one embodiment, the first information is transmitted through one of the first bearer and the second bearer other than the target bearer.

In one embodiment, the first information comprises a measurement result for a measurement object of the first node.

In one embodiment, the first operation set comprises resetting a MAC associated with the target bearer.

In one embodiment, the first operations set comprises information stored in a first state variant and related to the target bearer failure.

In one embodiment, only the first bearer in the first bearer and the second bearer is associated with a DRB.

In one embodiment, only the first bearer in the first bearer and the second bearer is associated with an MRB.

In one embodiment, the meaning of the phrase of the first operation set comprising at least a former of transmitting an RRC message or receiving an RRC message comprises: transmitting an RRCReestablishmentRequest message.

In one embodiment, the meaning of the phrase of the first operation set comprising at least a former of transmitting an RRC message or receiving an RRC message comprises: transmitting UEAssistanceInformation.

In one embodiment, the meaning of the phrase of the first operation set comprising at least a former of transmitting an RRC message or receiving an RRC message comprises: transmitting SidelinkUEInformation.

In one embodiment, the meaning of the phrase of the first operation set comprising at least a former of transmitting an RRC message or receiving an RRC message comprises: transmitting FailureInformation.

In one embodiment, the meaning of the phrase of the first operation set comprising at least a former of transmitting an RRC message or receiving an RRC message comprises: transmitting UEInformationResponse.

In one embodiment, the meaning of the phrase of the first operation set comprising at least a former of transmitting an RRC message or receiving an RRC message comprises: transmitting ulInformationTransfer.

In one embodiment, the meaning of the phrase of the first operation set comprising at least a former of transmitting an RRC message or receiving an RRC message comprises: transmitting RRCReconfigurationComplete.

### Embodiment 2

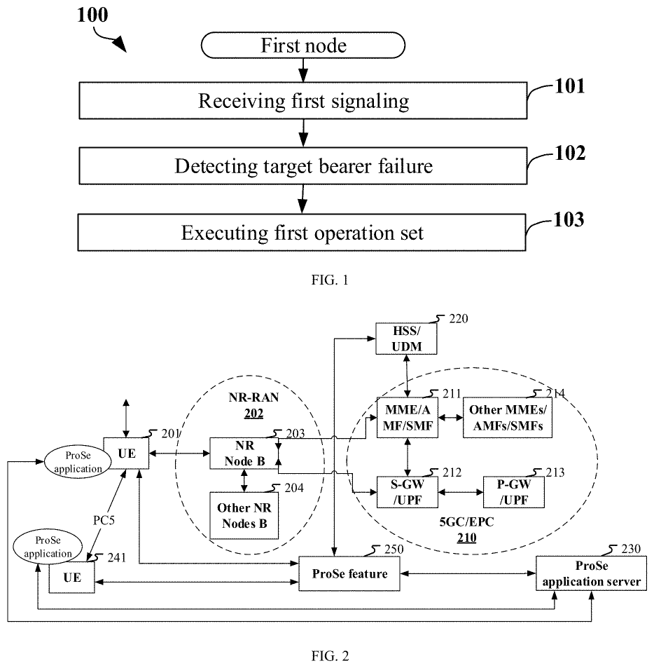

Embodiment 2 illustrates a schematic diagram of a network architecture according to the present application, as shown in FIG. 2.

FIG. 2 illustrates a network architecture 200 of 5G NR, Long-Term Evolution (LTE) and Long-Term Evolution Advanced (LTE-A) systems. The 5G NR or LTE network architecture 200 may be called a 5G System (5GS)/Evolved Packet System (EPS) 200 or other appropriate terms. The 5GS/EPS 200 may comprise one or more UEs 201, an NG-RAN 202, a 5G Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will readily understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPS), multimedia devices, video devices, digital audio players (for example, MP3 players), cameras, game consoles, unmanned aerial vehicles (UAV), aircrafts, narrow-band Internet of Things (I) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the first node in the present application is a UE 201.

In one embodiment, a base station of the first node in the present application is gNB 203.

In one embodiment, a radio link between the UE 201 and NR node B is an uplink.

In one embodiment, a radio link between NR node B and UE 201 is a downlink.

In one embodiment, the UE 201 supports relay transmission.

In one embodiment, the UE201 comprises a mobile phone.

In one embodiment, the UE 201 is a vehicle comprising a car.

In one embodiment, the UE 201 supports multiple-SIM cards.

In one embodiment, the UE 201 supports sidelink communications.

In one embodiment, the UE 201 supports MBS transmission.

In one embodiment, the UE 201 supports MBMS transmission.

In one embodiment, the gNB203 is a MarcoCellular base station.

In one embodiment, the gNB 203 is a Micro Cell base station.

In one embodiment, the gNB 203 is a PicoCell base station.

In one embodiment, the gNB 203 is a flight platform.

In one embodiment, the gNB 203 is satellite equipment.

### Embodiment 3

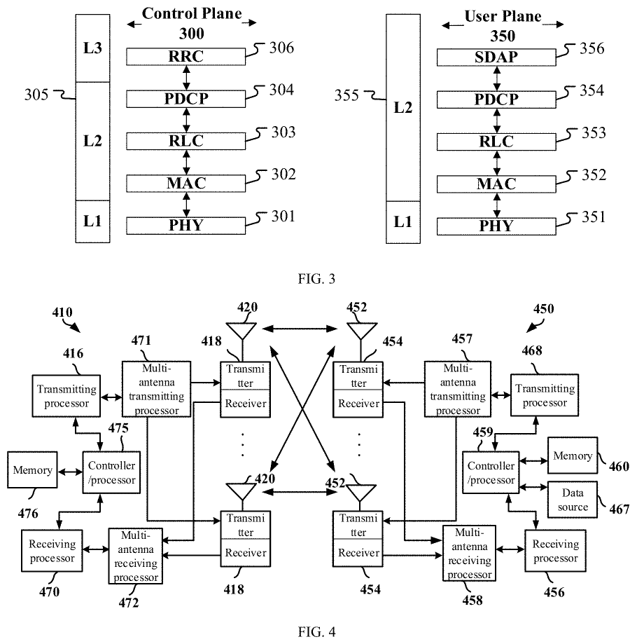

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first node (UE, gNB or a satellite or an aircraft in NTN) and a second node (gNB, UE or a satellite or an aircraft in NTN), or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first node and a second node, as well as two UEs via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second node. The PDCP sublayer 304 provides multiplexing among variable radio bearers and logical channels. The PDCP sublayer 304 provides security by encrypting a packet and provides support for a first node handover between second nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second node and a first node. PC5 Signaling Protocol (PC5-S) sublayer 307 is responsible for the processing of signaling protocol at PC5 interface. The radio protocol architecture of the user plane 350 comprises layer 1 (L1) and layer 2 (L2). In the user plane 350, the radio protocol architecture for the first node and the second node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in the figure, the first node may comprise several higher layers above the L2 305. also comprises a network layer (i.e., IP layer) terminated at a P-GW 213 of the network side and an application layer terminated at the other side of the connection (i.e., a peer UE, a server, etc.). For UE involving relay services, its control plane can also comprise the adaptation sub-layer Sidelink Relay Adaptation Protocol (SRAP) 308, and its user plane can also comprise the adaptation sub-layer SRAP 358, an introduction of the adaptation layer helps lower layers, such as MAC layer and RLC layer, multiplex and/or distinguish data from multiple source UEs.

In one embodiment, the radio protocol architecture in FIG. 3 is applicable to the first node in the present application.

In one embodiment, the radio protocol architecture in FIG. 3 is applicable to the second node in the present application.

In one embodiment, the first information in the present application is generated in the RRC 306 or the MAC 302.

In one embodiment, the first signaling in the present application is generated by the RRC 306.

In one embodiment, the second signaling in the present application is generated by the RRC 306.

In one embodiment, the third signaling in the present application is generated by the RRC 306.

In one embodiment, the fourth signaling in the present application is generated by the RRC 306.

### Embodiment 4

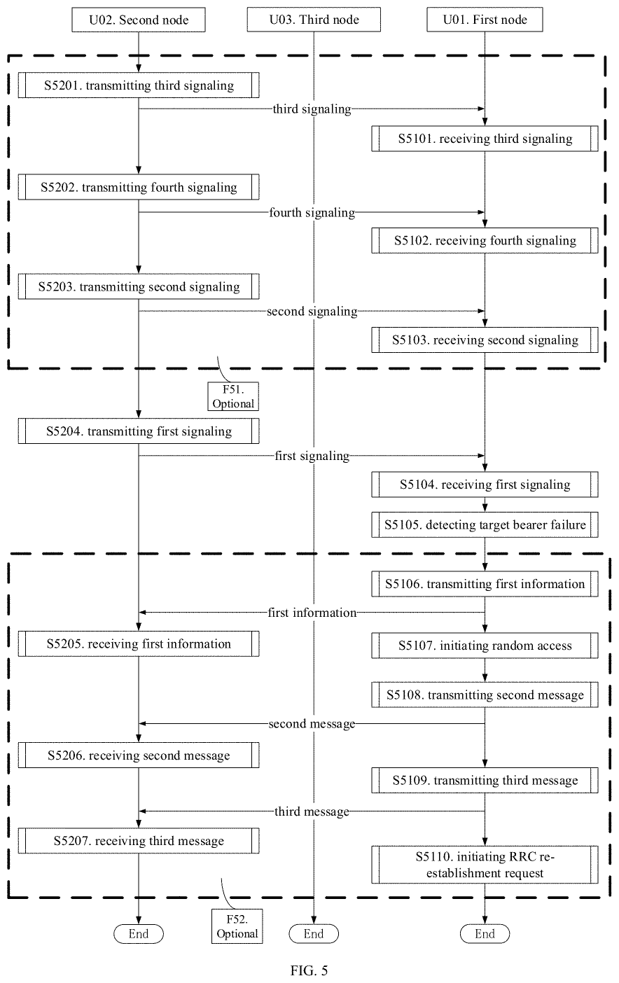

Embodiment 4 illustrates a schematic diagram of a first communication device and a second communication device according to one embodiment of the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, optionally may also comprise a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, optionally may also comprise a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises: at least one processor and at least one memory. The at least one memory comprises computer program codes; the at least one memory and the computer program codes are configured to be used in collaboration with the at least one processor, the first communication device 450 at least detects a first bearer failure; the first bearer is associated with a first cell group; as a response to the behavior of detecting a first bearer failure, executes a first operation set, the first operation set is related to a type of the first bearer; as a response to the behavior of detecting a first bearer failure, transmits first information; the first information is used to indicate the first bearer failure; as a response to all conditions in a first condition set being satisfied, transmits a second message; the second message indicates available information; herein, the first cell group is an MCG; the first condition set comprises that a first state variant stores available information; the meaning of the phrase of the first operation set being related to a type of the first bearer is: when the first bearer is a first-type bearer, the first operation set comprises at least one of re-establishing an RLC entity associated with the first bearer or storing information for the first bearer failure in the first state variant; when the first bearer is a second-type bearer, the first operation set comprises at least releasing an RLC entity associated with the first bearer.

In one embodiment, the first communication device 450 comprises at least one processor and at least one memory. a memory that stores a computer readable instruction program. The computer readable instruction program generates an action when executed by at least one processor. The action includes: detecting a first bearer failure; the first bearer being associated with a first cell group; as a response to the behavior of detecting a first bearer failure, executing a first operation set, the first operation set being related to a type of the first bearer; as a response to the behavior of detecting a first bearer failure, transmitting first information; the first information being used to indicate the first bearer failure; as a response to all conditions in a first condition set being satisfied, transmitting a second message; the second message indicating available information; herein, the first cell group is an MCG; the first condition set comprises that a first state variant stores available information; the meaning of the phrase of the first operation set being related to a type of the first bearer is: when the first bearer is a first-type bearer, the first operation set comprises at least one of re-establishing an RLC entity associated with the first bearer or storing information for the first bearer failure in the first state variant; when the first bearer is a second-type bearer, the first operation set comprises at least releasing an RLC entity associated with the first bearer.

In one embodiment, the first communication device 450 corresponds to a first node in the present application.

In one embodiment, the second communication device 410 corresponds to a second node in the present application.

In one embodiment, the first communication device 450 is a UE.

In one embodiment, the first communication device 450 is a vehicle terminal.

In one embodiment, the second communication device 450 is a relay.

In one embodiment, the second communication device 450 is a satellite.

In one embodiment, the second communication device 450 is an aircraft.

In one embodiment, the receiver 454 (comprising the antenna 452), the receiving processor 456 and the controller/processor 459 are used to receive the first signaling in the present application.

In one embodiment, the receiver 454 (comprising the antenna 452), the receiving processor 456 and the controller/processor 459 are used to receive the first signaling in the present application.

In one embodiment, the receiver 454 (comprising the antenna 452), the receiving processor 456 and the controller/processor 459 are used to receive the second signaling in the present application.

In one embodiment, the receiver 454 (comprising the antenna 452), the receiving processor 456 and the controller/processor 459 are used to receive the third signaling in the present application.

In one embodiment, the transmitter 454 (comprising antenna 452), the transmitting processor 468 and the controller/processor 459 are used to transmit the fourth signaling in the present application.

### Embodiment 5

Embodiment 5 illustrates a flowchart of radio signal transmission according to one embodiment in the present application, as shown in FIG. 5. In FIG. 5, U01 corresponds to a first node in the present application. It is particularly underlined that the order illustrated in the embodiment does not put constraints over sequences of signal transmissions and implementations and steps in F51 and F52 are optional.

The first node U01 receives a third signaling in step S5101; receives a fourth signaling in step S5102; receives a second signaling in step S5103; receives a first signaling in step S5104; detects a target bearer failure in step S5105; transmits first information in step S5106; initiates a random access in step S5107; transmits a second message in step S5108; transmits a third message in step S5109; and transmits an RRC re-establishment request in step S5110.

The second node U02 transmits a third signaling in step S5201; transmits a fourth signaling in step S5202; transmits a second signaling in step S5203; transmits a first signaling in step S5204; and receives first information in step S5205; receives a second message in step S5206; receives a third message in step S5207.

In embodiment 5, the first bearer is associated with a first cell group; the first node U01, as a response to the behavior of detecting a first bearer failure, executes a first operation set, the first operation set is related to a type of the first bearer;

the first node U01, as a response to the behavior of detecting a first bearer failure, transmits first information, the first information is used to indicate the first bearer failure, and as a response to all conditions in a first condition set being satisfied, transmits a second message; the second message indicates available information;

herein, the first cell group is an MCG; the first condition set comprises that a first state variant stores available information; the meaning of the phrase of the first operation set being related to a type of the first bearer is: when the first bearer is a first-type bearer, the first operation set comprises at least one of re-establishing an RLC entity associated with the first bearer or storing information for the first bearer failure in the first state variant; when the first bearer is a second-type bearer, the first operation set comprises at least releasing an RLC entity associated with the first bearer.

In one embodiment, the first node U01 is a U2N relay UE.

In one embodiment, the first node U01 is a U2N remote UE.

In one embodiment, the first node U01 is an NR ProSe U2N remote UE.

In one embodiment, a third node U03 is an L2 U2N relay UE.

In one embodiment, a third node U03 is a neighbor cell of the first node U01.

In one embodiment, both a third node U03 and the second U02 belong to a CU.

In one embodiment, both a third node U03 and the second U02 belong to a DU.

In one embodiment, both a third node U03 and the second U02 belong to a gNB.

In one embodiment, a third node U03 and the second node U02 are respectively cells with different physical cell identities (PCIs).

In one embodiment, a third node U03 and the second node U02 are respectively cells within the first cell group.

In one embodiment, a third node U03 is another TRP of the second node.

In one embodiment, a third node U03 is another beam of the second node U02, which corresponds to another group of CSI-RS reference signals.

In one embodiment, the second node U02 is a base station.

In one embodiment, the second node U02 is a PCell of the first node U01.

In one embodiment, the second node U02 is an MCG of the first node U01.

In one embodiment, the second node U02 corresponds to a first cell group in the present application or a base station corresponding to a first cell group.

In one embodiment, the second bearer uses the third node U03.

In one embodiment, the second bearer is associated with the third node U03.

In one embodiment, the second bearer is an indirect path, and a relay involved by the second bearer is the third node U03.

In one embodiment, the second bearer is or comprises a sidelink radio link between the first node U01 and the third node U03.

In one embodiment, the second bearer is or comprises a link between the first node U01 and the third node U03.

In one embodiment, the second bearer is or comprises a direct link between the first node U01 and the third node U03.

In one embodiment, the second bearer is or comprises a direct unicast link between the first node U01 and the third node U03.

In one embodiment, the second bearer is or comprises a sidelink RLC bearer between the first node U01 and the third node U03.

In one embodiment, the second bearer is or comprises a channel between the first node U01 and the third node U03.

In one embodiment, the second bearer is or comprises a radio link between the second node U02 and the third node U03.

In one embodiment, the second bearer is or comprises an RLC bearer between the second node U02 and the third node U03.

In one embodiment, the second bearer is or comprises a link between the second node U02 and the third node U03.

In one embodiment, the second bearer is or comprises a channel between the second node U02 and the third node U03.

In one embodiment, the first signaling is directly transmitted by the second node U02 to the first node without through relay.

In one embodiment, the first signaling is forwarded to the first node U01 by the second node U02 through the third node U03.

In one embodiment, the first signaling is transmitted to the first node U01 by the second node U02 through both relay forwarding and direct transmitting at the same time.

In one embodiment, the first signaling is an RRC signaling.

In one embodiment, the first signaling comprises an SIB12.

In one embodiment, the first signaling comprises an RRCReconfiguration.

In one embodiment, the first signaling comprises are configurationWithSync.

In one embodiment, the first signaling comprises cellgroupconfig.

In one embodiment, the first signaling comprises masterCellGroup.

In one embodiment, the first signaling does not comprise secondaryCellGroup.

In one embodiment, the first bearer is configured through radioBearerConfig comprised in the first signaling.

In one embodiment, the first bearer is configured through masterCellGroup comprised in the first signaling.

In one embodiment, the first bearer is configured through spCellGroup comprised in the first signaling.

In one embodiment, the second bearer is configured through SL-ConfigDedicatedNR comprised in the first signaling.

In one embodiment, the second bearer is configured through sl-L2RemoteConfig comprised in the first signaling.

In one embodiment, the first bearer is a bear without through relay between the first node U01 and the second node U02.

In one embodiment, the second bearer is a bearer relaying through the third node U03 between the first node U01 and the second node U02.

In one embodiment, the first bearer is an RLC bearer between the first node U01 and the second node U02.

In one embodiment, the first bearer is a radio link between the first node U01 and the second node U02.

In one embodiment, a protocol entity corresponding to the first bearer is located at the first node U01 and the second node U02.

In one embodiment, the second bearer is a sidelink RLC bearer between the first node U01 and the third node U03 for transmitting data between the first node U01 and the second node U02.

In one embodiment, the second bearer is a sidelink radio bearer between the first node U01 and the third node U03.

In one embodiment, a protocol entity corresponding to the second bearer is located at the first node U01 and the third node U03.

In one embodiment, both the first bearer and the second bearer are used to process data between the first node U01 and the second node U02.

In one embodiment, the first signaling is used to configure the first bearer.

In one embodiment, the first signaling is used to configure the second bearer, and the second signaling is associated with the first cell group.

In one subembodiment of the above embodiment, the first bearer is the first bearer, and the second bearer is the second bearer.

In one subembodiment of the above embodiment, the first bearer is the second bearer, and the second bearer is the first bearer.

In one embodiment, the first node U01 sets a primary path of a PDCP entity of SRB1 for the second bearer after detecting a first bearer failure in step S5105 and before transmitting first information in step S5106;

herein, the first signaling indicates that SRB1 is associated with the first bearer and the second bearer at the same time and a primary path of a PDCP entity of SRB1 is for the first bearer; SRB1 is not configured with a PDCP repetition.

In one subembodiment of the above embodiment, the first information comprises a first measurement result.

In one subembodiment of the above embodiment, the first information is used to indicate whether the target bearer is the second bearer.

In one subembodiment of the above embodiment, SRB1 of the first node U01 is an SRB between the first node U01 and the second node U02.

In one subembodiment of the above embodiment, the meaning of the phrase of the first signaling indicating that SRB1 being associated with the first bearer and the second bearer at the same time is: both the first bearer and the second bearer are associated with the SRB1.

In one subembodiment of the above embodiment, the meaning of the phrase of the first signaling indicating that SRB1 being associated with the first bearer and the second bearer at the same time is: both the first bearer and the second bearer have a mapping relation with the SRB1.

In one subembodiment of the above embodiment, the meaning of the phrase of the first signaling indicating that SRB1 being associated with the first bearer and the second bearer at the same time is: both the first bearer and the second bearer are used to transmit data of the SRB1.

In one subembodiment of the above embodiment, the meaning of the phrase of the first signaling indicating that SRB1 being associated with the first bearer and the second bearer at the same time is: data of an SRB1 of the first node U01 can be transmitted in any of the first bearer and the second bearer.

In one subembodiment of the above embodiment, the meaning of the phrase of the first signaling indicating that SRB1 being associated with the first bearer and the second bearer at the same time is: data of SRB1 of the first node U1 can be repeatedly transmitted on the first bearer and the second bearer.

In one subembodiment of the above embodiment, the SRB1 corresponds and only corresponds to a PDCP entity, that is, a PDCP entity of the SRB1.

In one subembodiment of the above embodiment, the meaning of the phrase of SRB1 not being configured with a PDCP-Duplication is: SRB1 of the first node U01 is not configured with pdcp-Duplication.

In one subembodiment of the above embodiment, the meaning of the phrase of SRB1 being not configured with a PDCP repetition is: a value of a pdcp-Duplication field configured to SRB1 of the first node U01 is false.

In one subembodiment of the above embodiment, the first measurement result comprised in the first information comprises a measurement result on main link.

In one subembodiment of the above embodiment, the first measurement result comprised in the first information comprises a measurement result on sidelink radio link.

In one subembodiment of the above embodiment, the first measurement result comprised in the first information comprises a measurement result for a measurement object configured for the first node U01.

In one subembodiment of the above embodiment, the first measurement result comprised in the first information comprises RSRP and/or RSRQ for the second node U02.

In one subembodiment of the above embodiment, the first measurement result comprised in the first information comprises RSRP for the third node U03.

In one subembodiment of the above embodiment, the first measurement result comprised in the first information comprises a measurement result for a neighbor cell.

In one subembodiment of the above embodiment, the first measurement result comprised in the first information comprises a measurement result for a beam of the second node U02.

In one subembodiment of the above embodiment, the first measurement result comprised in the first information comprises a measurement result for a candidate relay.

In one subembodiment of the above embodiment, the first information explicitly indicates whether the first bearer is the second bearer.

In one subembodiment of the above embodiment, the first information implicitly indicates whether the first bearer is the second bearer.

In one subembodiment of the above embodiment, a PDCP entity of SRB1 of the first node U01 at most has one primary path.

In one subembodiment of the above embodiment, the meaning of the phrase of the first signaling indicating that SRB1 being associated with the first bearer and the second bearer at the same time and a primary path of a PDCP entity of SRB1 being for the first bearer is: an identity of a cell group of a primary path of a PDCP entity of SRB1 of the first node U01 is an identity of the first cell that the first bearer is for.

In one subembodiment of the above embodiment, the meaning of the phrase of the first signaling indicating that SRB1 being associated with the first bearer and the second bearer at the same time and a primary path of a PDCP entity of SRB1 being for the first bearer is: an identity of a logical channel of a primary path of a PDCP entity of SRB1 of the first node U01 is an identity of the first bearer.

In one subembodiment of the above embodiment, the meaning of the phrase of the first signaling indicating that SRB1 being associated with the first bearer and the second bearer at the same time and a primary path of a PDCP entity of an SRB1 being for the first bearer is: an identity of a logical channel of a primary path of a PDCP entity of SRB1 of the first node U01 is an identity of a logical channel associated with or used by the first bearer.

In one subembodiment of the above embodiment, the meaning of the behavior of setting a primary path of a PDCP path of SRB1 for the second bearer is: setting an identity of a cell group of a primary path of a PDCP entity of SRB1 of the first node U01 as an identity of the first cell group associated with the second bearer.

In one subembodiment of the above embodiment, the meaning of the behavior of setting a primary path of a PDCP path of SRB1 for the second bearer is: setting an identity of a logical channel of a primary path of a PDCP entity of SRB1 of the first node U01 as an identity of the second bearer.

In one subembodiment of the above embodiment, the meaning of the behavior of setting a primary path of a PDCP path of SRB1 for the second bearer is: setting an identity of a logical channel of a primary path of a PDCP entity of SRB1 of the first node U01 as an identity of a sidelink logical identity associated with the second bearer.

In one subembodiment of the above embodiment, the meaning of the behavior of setting a primary path of a PDCP path of SRB1 for the second bearer is: setting an identity of a logical channel of a primary path of a PDCP entity of SRB1 of the first node U01 as an identity of a sidelink logical identity occupied by the second bearer.

In one subembodiment of the above embodiment, the meaning of the behavior of setting a primary path of a PDCP path of SRB1 for the second bearer is: setting an identity of a node of a primary path of a PDCP entity of SRB1 of the first node U01 as an identity of a relay associated with the second bearer.

In one subembodiment of the above embodiment, the meaning of the behavior of setting a primary path of a PDCP entity of SRB1 for the second bearer is: setting an identity of a node of a primary path of a PDCP entity of SRB1 of the first node U01 as an identity of the third node U03.

In one embodiment, the first information uses the first bearer for a transmission.

In one subembodiment of the above embodiment, the target bearer is the second bearer.

In one subembodiment of the above embodiment, the first information is at least partial fields in an RRC message for the second node U02.

In one embodiment, the step S51051 of detecting a target bearer failure comprises: detecting that a radio link failure occurs in the first bearer.

In one embodiment, the step S51051 of detecting a target bearer failure comprises: detecting that a radio link failure occurs in a radio link between the first node U01 and the second node U02.

In one embodiment, the step S51051 of detecting a target bearer failure comprises: detecting that timer T310 is expired.

In one embodiment, the step S51051 of detecting a target bearer failure comprises: detecting that timer T312 is expired.

In one embodiment, the step S51051 of detecting a target bearer failure comprises: detecting that timer T304 is expired.

In one embodiment, the step S51051 of detecting a target bearer failure comprises: detecting that a problem occurs in a random access procedure for the second node U02.

In one embodiment, the step S51051 of detecting a target bearer failure comprises: detecting that the first bearer reaches RLC maximum repetitions.

In one embodiment, the step S51051 of detecting a target bearer failure comprises: detecting occurring continuous LBT failures.

In one embodiment, as a response to detecting a target bearer failure in step S5105, the first node U01 executes the first operation set, and the target bearer is the first bearer.

In one subembodiment of the embodiment, the first operation comprises re-establishing an RLC entity associated with the first bearer, and does not comprises information for the first bearer failure stored in the first state variant.

In one subembodiment of the embodiment, the first operation comprises storing information for the first bearer failure in the first state variant, and does not comprise re-establishing an RLC entity associated with the first bearer.

In one subembodiment of the embodiment, the first operation comprises storing information for the first bearer failure in the first state variant, and comprises re-establishing an RLC entity associated with the first bearer.

In one embodiment, the third signaling is used to indicate a path switch for the target bearer;

herein, the first operation set comprises: executing the third signaling; a reception of the third signaling is earlier than the behavior of detecting the target bearer failure.

In one subembodiment of the embodiment, the third signaling comprises sl-PathSwitchConfig.

In one subembodiment of the embodiment, the third signaling is an RRC message.

In one subembodiment of the embodiment, the third signaling is or comprises an RRCReconfiguration message.

In one subembodiment of the embodiment, the third signaling indicates switching from an indirect path to another indirect path.

In one subembodiment of the embodiment, the third signaling indicates switching from an indirect path to a direct path.

In one subembodiment of the embodiment, the target bearer is the first bearer, and the third signaling is used to indicate switching from a direct path to an indirect path.

In one subembodiment of the embodiment, the target bearer is the second bearer, and the third signaling is used to indicate switching from a direct path to an indirect path.

In one subembodiment of the embodiment, the target bearer is the first bearer, and the third signaling is used to indicate switching from an indirect path to a direct path.

In one subembodiment of the embodiment, as a response to a first execution condition being satisfied, the third signaling is executed, and the first execution condition is associated with the third signaling.

In one subembodiment of the embodiment, as a response to a first execution condition set being satisfied, the first node U01 executes relay selection and the selected relay is the first relay.

In one subembodiment of the embodiment, as a response to a first execution condition set being satisfied, the first node U01 executes relay selection and the selected relay is the second relay.

In one subembodiment of the embodiment, as a response to a first execution condition set being satisfied, the first node executes relay selection and the selected relay is an L2 U2N relay UE other than the first relay.

In one subembodiment of the embodiment, the third signaling indicates that the first bearer executes a path switch to the second bearer.

In one subembodiment of the embodiment, the third signaling indicates that the first bearer executes a path switch to a bearer related to relay other than the second bearer.

In one subembodiment of the embodiment, the third signaling indicates that the first bearer executes a path switch to an indirect path other than the second bearer.

In one subembodiment of the embodiment, the third signaling is not executed immediately after being received, but is executed after the first execution condition is satisfied.

In one embodiment, the first node U01 receives a fourth signaling in step S5102, and the fourth signaling is used to configure a fourth bearer; the behavior of configuring the fourth bearer comprises setting the fourth bearer as a deactivated state;

herein, the first operation set comprises: activating the fourth bearer; the first operation set comprises: at least one of suspending the second bearer, deactivating the second bearer or releasing the second bearer; the target bearer is the second bearer.

In one subembodiment of the embodiment, the meaning of the phrase of the behavior of configuring the fourth bearer comprises setting the fourth bearer as a deactivated state is: the fourth signaling explicitly indicates setting the fourth bearer as an inactive state.

In one subembodiment of the embodiment, the meaning of the phrase of the behavior of configuring the fourth bearer comprises setting the fourth bearer as a deactivated state is: the fourth signaling implicitly indicates setting the fourth bearer as an inactive state, that is, not indicating setting the fourth bearer as an active state.

In one subembodiment of the embodiment, the meaning of the phrase of the behavior of configuring the fourth bearer comprises setting the fourth bearer as a deactivated state is: a reception of the fourth signaling triggers setting the fourth bearer as an active state.

In one subembodiment of the embodiment, the meaning of the phrase of the behavior of configuring the fourth bearer comprises setting the fourth bearer as a deactivated state is: a reception of the fourth signaling triggers setting the fourth bearer as an active state.

In one subembodiment of the embodiment, the meaning of the phrase of the behavior of configuring the fourth bearer comprises setting the fourth bearer as a deactivated state is: receiving the fourth signaling, the first node U01 configures the fourth bearer according to the fourth signaling and sets the fourth bearer as an active state.

In one subembodiment of the embodiment, the fourth signaling is an RRC signaling.

In one subembodiment of the embodiment, the fourth signaling is or comprises RRCReconfiguration.

In one subembodiment of the embodiment, the fourth signaling indicates at least one candidate relay.

In one subembodiment of the embodiment, the fourth signaling indicates an identity of at least one candidate L2 U2N relay UE.

In one subembodiment of the embodiment, the fourth bearer is an indirect path.

In one subembodiment of the embodiment, the fourth bearer is related to a candidate relay.

In one subembodiment of the embodiment, the fourth bearer is associated with the first cell group.

In one subembodiment of the embodiment, the fourth bearer is used to transmit a PDCP PDU between the first node U01 and the second node U02.

In one subembodiment of the embodiment, the fourth bearer is used to bear a radio bearer between the first node U01 and the first cell group.

In one subembodiment of the embodiment, the fourth bearer is used to bear a first radio bearer of the first node U01 for the first cell group; the second bearer is used to bear a first radio bearer of the first node U01 for the first cell group, and the first radio bearer is an RB.

In one subembodiment of the embodiment, a relay associated with the fourth bearer is a third relay, and the third relay is not the first relay.

In one subembodiment of the embodiment, a relay associated with the fourth bearer is a node other than the third node U03.

In one subembodiment of the embodiment, the fourth bearer comprises a radio link between the first node U01 and a candidate relay.

In one subembodiment of the embodiment, the fourth bearer comprises a sidelink radio link between the first node U01 and a candidate relay.

In one subembodiment of the embodiment, the fourth bearer comprises a sidelink RLC bearer between the first node U01 and a candidate relay.

In one subembodiment of the embodiment, the fourth bearer comprises a sidelink radio link between the first node U01 and a candidate relay as well as a radio link between the candidate relay and the first cell group.

In one subembodiment of the embodiment, the fourth bearer comprises a sidelink RLC bearer between the first node U01 and a candidate relay as well as an RLC bearer between the candidate relay and the first cell group.

In one subembodiment of the embodiment, the fourth bearer comprises a channel between the first node U01 and a candidate relay.

In one subembodiment of the embodiment, the first node U01 only transmits data on a bearer in an activate state.

In one subembodiment of the embodiment, the first node U01 only transmits data on the fourth bearer in an activated state.

In one subembodiment of the embodiment, the first node U01 only transmits data on the second bearer in an activated state.

In one subembodiment of the embodiment, the meaning of the behavior of deactivating the second bearer is setting the second bearer as a deactivated state.

In one embodiment, the first node U01 receives a second signaling in step S5103, and as a response to receiving the second signaling, starts a first timer;

herein, when the behavior of detecting that a target bearer failure is executed, the first timer is running; the second signaling comprises a first field, the first field is reconfigurationWithSync, the first field is used to indicate a path switch for the second bearer, and the target bearer is the first bearer; the first timer is a timer other than T304.

In one subembodiment of the embodiment, the first timer is T404.

In one subembodiment of the embodiment, the first timer is one of T304a, T304b, T304c and T304r.

In one subembodiment of the above embodiment, a name of the first timer comprises r or comprises relay.

In one subembodiment of the above embodiment, the meaning of the phrase of detecting that a target bearer failure is executed is: when the target bearer is detected a failure.

In one subembodiment of the embodiment, the second signaling comprises sl-PathSwitchConfig.

In one subembodiment of the above embodiment, a stopping condition of the first timer is receiving a specific signal on sidelink.

In one embodiment, the step S5105 is executed after the step S5104.

In one embodiment, the first operation set comprises: releasing the second bearer, suspending SRB1 associated with the target bearer; the first operation set comprises: executing any of cell selection and relay selection;

herein, the first operation set comprises transmitting an RRC re-establishment request message.

In one subembodiment of the above embodiment, the step S5110 belongs to the first operation set.

In one subembodiment of the above embodiment, the meaning of the phrase of executing any of cell selection and relay selection is: executing cell selection and not executing relay selection.

In one subembodiment of the above embodiment, the meaning of the phrase of executing any of cell selection and relay selection is: not executing cell selection and executing relay selection.

In one subembodiment of the above embodiment, the meaning of the phrase of executing any of cell selection and relay selection is: executing cell selection and also executing relay selection.

In one subembodiment of the above embodiment, the RRC re-establishment request message is or comprise an RRCReestablishmentRequest message.

In one subembodiment of the above embodiment, the first node U01 determines executing which of cell selection and relay selection or executing both according to the internal algorithm implementation.

In one subembodiment of the above embodiment, the first operation set comprises initiating a random access procedure.

In one subembodiment of the above embodiment, the first operation set does not comprise initiating a random access procedure.

In one subembodiment of the above embodiment, the first node determines whether a random access procedure is initiated according to whether the synchronization requirements are met.

In one embodiment, whether the first operation set comprises initiating a random access is related to whether the target bearer is the first bearer or the second bearer; when the target bearer is the first bearer, the first operation set comprises initiating a random access procedure; when the target bearer is the second bearer, the first operation set does not comprise initiating a random access procedure.

In one subembodiment of the above embodiment, the behavior of initiating a random access is for the second node U02.

In one subembodiment of the above embodiment, the behavior of initiating a random access is for a node other than the second node U02.

In one subembodiment of the above embodiment, the behavior of initiating a random access is for a cell other than the second node U02.

In one embodiment, the step S5110 belongs to an RRC re-establishment procedure.

In one embodiment, the RRC re-establishment procedure comprises initiating an RRC re-establishment request for the second node U02.

In one embodiment, the RRC re-establishment procedure comprises transmitting an RRC re-establishment request for a node other than the second node U02.

In one embodiment, the RRC re-establishment procedure comprises forwarding an RRC re-establishment request through the third node U03.

In one embodiment, an RLC entity associated with the first bearer is an RLC entity of a Uu interface.

In one subembodiment of the above embodiment, an RLC entity of the Uu interface corresponds to an RLC 303 in embodiment 3.

In one subembodiment of the above embodiment, an RLC entity of the Uu interface corresponds to an RLC 353 in embodiment 353.

In one subembodiment of the above embodiment, an RLC entity of the Uu interface is a Uu-RLC entity in embodiment 7 (c).

In one embodiment, an RLC entity associated with the second bearer is an RLC entity of a PC5 interface.

In one subembodiment of the above embodiment, an RLC entity of the PC5 interface is a PC5-RLC entity in embodiment 7 (a) or (b).

In one embodiment, the first operation set comprises: storing information for the target bearer failure in a first state variant.

In one subembodiment of the above embodiment, the behavior of storing information for the target bearer failure in a first state variant comprises: storing an identity of the first cell group.

In one subembodiment of the above embodiment, the behavior of storing information for the target bearer failure in a first state variant comprises: storing an identity of a PCell of the first cell group.

In one subembodiment of the above embodiment, the behavior of storing information for the target bearer failure in a first state variant comprises: storing a cause of the target bearer failure.

In one subembodiment of the above embodiment, the behavior of storing information for the target bearer failure in a first state variant comprises: storing a type of the target bearer failure.

In one subembodiment of the above embodiment, the behavior of storing information for the target bearer failure in a first state variant comprises: storing whether a second-type bearer is used.

In one subembodiment of the above embodiment, the behavior of storing information for the target bearer failure in a first state variant comprises: storing a measurement result.

In one subembodiment of the above embodiment, the behavior of storing information for the target bearer failure in a first state variant comprises: storing a measurement result of a configured measured object.

In one subembodiment of the above embodiment, the behavior of storing information for the target bearer failure in a first state variant comprises: storing an identity of a used L2 U2N relay UE.

In one subembodiment of the above embodiment, the target bearer is the first bearer.

In one subembodiment of the above embodiment, the target bearer is the second bearer.

In one embodiment, the second message is an RRC message.

In one embodiment, the second message is used to indicate that an execution of an operation of an RRC layer is completed.

In one embodiment, the second message comprises an RRCReconfigurationComplete.

In one embodiment, the second message comprises RRCResumeComplete.

In one embodiment, the second message comprises RRCSetupComplete.

In one embodiment, the second message comprises RRCReestablishmentComplete.

In one embodiment, the second message indicates available information.

In one embodiment, the meaning of the phrase of the second message indicating available information is: the first node has or stores available information.

In one embodiment, the meaning of the phrase of the second message indicating available information is: the available information comprises information of the target bearer failure.

In one embodiment, the meaning of the phrase of the second message indicating available information is: the available information comprises information of the target-type bearer failure.

In one embodiment, the meaning of the phrase of the second message indicating available information is: the available information comprises radio link failure information.

In one embodiment, the meaning of the phrase of the second message indicating available information is: the available information comprises cell-handover failure information.

In one embodiment, the meaning of the phrase of the second message indicating available information is: the available information comprises path-transition failure information.

In one embodiment, the meaning of the phrase of the second message indicating available information is: the second message comprises an enumerated field with a value of true to indicate that there is available information.

In one embodiment, the meaning of the phrase of the second message indicating available information is: the second message comprises a field whose name comprises available with a value of true to indicate that there is available information.

In one embodiment, the meaning of the phrase of the second message indicating available information is: a UE-MeasurementsAvailable field of the second message indicates available information.

In one embodiment, the meaning of the phrase of the second message indicating available information is: a rlf-InfoAvailable field of aUE-MeasurementsAvailable field of the second message indicates available information.

In one embodiment, the meaning of the phrase of the second message indicating available information is: there exists information being available and being related to the target bearer failure.

In one embodiment, the meaning of the phrase of the second message indicating available information is: there exists information being available and being related to the first bearer failure.

In one embodiment, the meaning of the phrase of the second message indicating available information is: there exists information being available and being related to the first bearer failure.

In one embodiment, the meaning of the phrase of the second message indicating available information is: information related to the target bearer failure and stored in the first state variant is the available information.

In one embodiment, the meaning of the phrase of the second message indicating available information is: information related to the first bearer failure and stored in the first state variant is the available information.

In one embodiment, the third message is an RRC message.

In one embodiment, the third message comprises UEAssistanceInformation.

In one embodiment, the third message comprises SidelinkUElnformation.

In one embodiment, the third message comprises FailureInformation.

In one embodiment, the third message comprises a UElnformationResponse.

In one embodiment, the third message comprises a ULInformationTransfer.

In one embodiment, the third message is or comprises RRCReconfigurationComplete.

In one subembodiment of the embodiment, the third message is used to indicate path-transition complete.

In one subembodiment of the embodiment, the third message is used to indicate cell-handover complete.

In one embodiment, the third message comprises information of the target bearer failure.

In one embodiment, the third message comprises rlf-report.

In one embodiment, the first state variant is used to generate the third message.

In one embodiment, the third message uses the first bearer.

In one embodiment, the third message uses the second bearer.

In one embodiment, the third message uses the first bearer.

In one embodiment, the third message uses the second bearer.

In one embodiment, the third message neither uses the first bearer nor the second bearer.

In one embodiment, as a response to executing the third signaling, the first node U01 transmits the third message.

In one embodiment, as a response to executing the fourth signaling, the first node U01 transmits the third message.

In one embodiment, as a response to activating the fourth bearer, the first node U01 transmits the third message.

In one embodiment, as a response to completing a path switch, the first node U01 transmits the third message.

In one embodiment, as a response to the target path recovery, the first node U01 transmits the third message.

In one embodiment, one of the first bearer and the second bearer is an MRB and the other one is a DRB.

In one embodiment, the first bearer is for broadcast or groupcast services.

In one embodiment, the first bearer is a PTM branch of an MRB.

In one embodiment, the second bearer is for broadcast or groupcast services.

In one embodiment, the second bearer is for unicast services.

In one embodiment, the second bearer is a PTP branch for broadcast or groupcast services.

### Embodiment 6

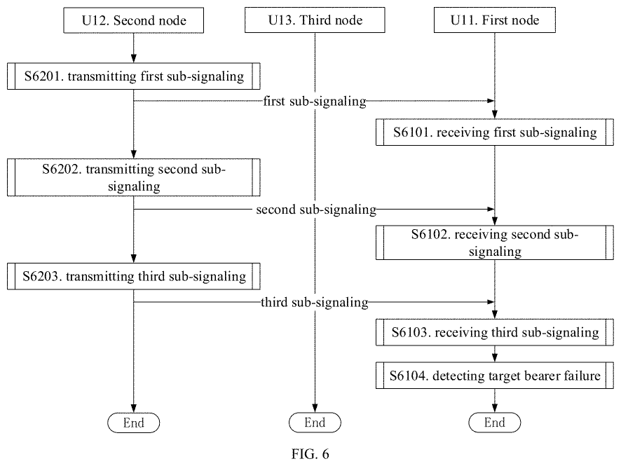

Embodiment 6 illustrates a flowchart of radio signal transmission according to one embodiment of the present application, as shown in FIG. 6. In FIG. 6, U11 corresponds to a first node in the present application. It is particularly underlined that the order illustrated in the embodiment does not put constraints over sequences of signal transmissions and implementations in the present application. Embodiment 6 is based on embodiment 5, and the parts required but not explicitly shown in embodiment 6 can refer to embodiment 5.

The first node U11 receives a first sub-signaling in step S6101; receives a second sub-signaling in step S6102; receives a third sub-signaling in step S6103; detects a target bearer failure in step S6104.

The second node U12 transmits a first sub-signaling in step S6201; transmits a second sub-signaling in step S6201; transmits a third sub-signaling in step S6203.

In one embodiment, the first node U11 is a U2N relay UE.

In one embodiment, the first node U11 is a U2N remote UE.

In one embodiment, the first node U11 is an NR ProSe U2N remote UE.

In one embodiment, a third node U13 is an L2 U2N relay UE.

In one embodiment, a third node U13 is a neighbor cell of the first node U11.

In one embodiment, a third node U13 and the second node U12 belong to a CU at the same time.

In one embodiment, a third node U13 and the second U12 belong to a DU at the same time.

In one embodiment, a third node U13 and the second U12 belong to a gNB at the same time.

In one embodiment, a third node U13 and the second node U12 are respectively cells with different physical cell identities (PCI).

In one embodiment, a third node U13 and the second node U12 are respectively cells within the first cell group.

In one embodiment, a third node U13 is another TRP of the second node U12

In one embodiment, a third node U13 is another beam of the second node U12, correspond to another group of CSI-RS reference signals.

In one embodiment, the second node U12 is a base station.

In one embodiment, the second node U12 is a PCell of the first node U11.

In one embodiment, the second node U12 is an MCG of the first node U11.

In one embodiment, the second node U12 corresponds to a first cell group in the present application or a base station corresponding to a first cell group.

In one embodiment, the third node U13 is the first relay.

In one embodiment, the second bearer uses the third node U13.

In one embodiment, the second bearer is associated with the third node U13.

In one embodiment, the second bearer is an indirect path, and a relay involved by the second bearer is the third node U13.

In one embodiment, the second bearer is or comprises a sidelink radio link between the first node U11 and the third node U13.

In one embodiment, the second bearer is or comprises a link between the first node U11 and the third node U13.

In one embodiment, the second bearer is or comprises a direct link between the first node U11 and the third node U13.

In one embodiment, the second bearer is or comprises a direct unicast link between the first node U11 and the third node U13.

In one embodiment, the second bearer is or comprises a sidelink RLC bearer between the first node U11 and the third node U13.

In one embodiment, the second bearer is or comprises a channel between the first node U11 and the third node U13.

In one embodiment, the second bearer is or comprises a radio link between the second node U12 and the third node U13.

In one embodiment, the second bearer is or comprises an RLC bearer between the second node U12 and the third node U13.

In one embodiment, the second bearer is or comprises a link between the second node U12 and the third node U13.

In one embodiment, the second bearer is or comprises a channel between the second node U12 and the third node U13.

In one embodiment, the first signaling comprises the first sub-signaling, a second sub-signaling and a third sub-signaling.

In one embodiment, the first sub-signaling, the second sub-signaling and the third sub-signaling are respectively different fields comprised in the first signaling.

In one embodiment, at least one sub-signaling in the first sub-signaling, the second sub-signaling and the third sub-signaling is a different field comprised in the first signaling.

In one embodiment, at least one sub-signaling in the first sub-signaling, the second sub-signaling and the third sub-signaling is an RRC message.

In one embodiment, the first sub-signaling, the second sub-signaling and the third sub-signaling are transmitted at the same time.

In one subembodiment of the above embodiment, the meaning of the phrase of being transmitted at the same time is: being transmitted in a same RRC message.

In one subembodiment of the above embodiment, the meaning of the phrase of being transmitted at the same time is: being transmitted in a same MAC PDU.

In one embodiment, the first sub-signaling, the second sub-signaling and the third sub-signaling are not transmitted at the same time.

In one subembodiment of the above embodiment, the meaning of the phrase of not being transmitted at the same time is: the first sub-signaling, the second sub-signaling and the third sub-signaling are transmitted through at least two RRC messages.

In one subembodiment of the above embodiment, the meaning of the phrase of not being transmitted at the same time is: the first sub-signaling, the second sub-signaling and the third sub-signaling are transmitted through at least two MAC PDUs.

In one embodiment, the first sub-signaling and the second sub-signaling belong to a same RRC message, and the first sub-signaling and the third sub-signaling belong to different RRC messages.

In one embodiment, the first signaling comprises multiple RRC messages.

In one embodiment, the step S6104 is taken after the step S6103.

In one embodiment, the step S6104 is taken after the step S6102.

In one embodiment, the step S6104 is taken after the step S6101.

In one embodiment, the first signaling comprises a first sub-signaling, the second sub-signaling and a third sub-signaling, the first sub-signaling is used to configure the first bearer, the third sub-signaling is used to configure the third bearer, and the second sub-signaling is used to configure the second bearer; the third bearer is associated with a second relay, the second relay is an L2 U2N relay UE, and the first relay is different from the second relay.

In one subembodiment of the embodiment, the third bearer is an indirect path.

In one subembodiment of the embodiment, the third bearer uses the second relay.

In one subembodiment of the embodiment, the first relay is the third node U13.

In one subembodiment of the embodiment, the second relay is a node other than the third node U13.

In one subembodiment of the embodiment, data carried by the third bearer is forwarded through the second relay.

In one subembodiment of the embodiment, the third bearer is or comprises a sidelink radio link between the first node U11 and the second relay.

In one subembodiment of the embodiment, the third bearer is or comprises a sidelink RLC bearer between the first node U11 and the second relay.

In one subembodiment of the embodiment, the third bearer is or comprises a sidelink channel between the first node U11 and the second relay.

In one subembodiment of the embodiment, the third bearer is or comprises a direct link between the first node U11 and the second relay.

In one subembodiment of the embodiment, the third bearer is or comprises a radio link between the second relay and the first cell group.

In one subembodiment of the embodiment, the third bearer is or comprises an RLC bearer between the second relay and the first cell group.

In one subembodiment of the embodiment, the third bearer is or comprises a channel between the second relay and the first cell group.

In one subembodiment of the embodiment, the first sub-signaling comprises configuration parameters of an RLC entity corresponding to the first bearer.

In one subembodiment of the embodiment, the first sub-signaling comprises configuration parameters of a PDCP entity corresponding to the first bearer.

In one subembodiment of the embodiment, the first sub-signaling comprises configuration parameters of a MAC corresponding to the first bearer.

In one subembodiment of the embodiment, the first sub-signaling indicates resources occupied by the first bearer.

In one subembodiment of the embodiment, the first sub-signaling comprises configuration parameters of a sidelink RLC entity corresponding to the second bearer.

In one subembodiment of the embodiment, the first sub-signaling indicates a radio link associated with the second bearer.

In one subembodiment of the embodiment, the first sub-signaling comprises configuration parameters of a MAC corresponding to the second bearer.

In one subembodiment of the embodiment, the first sub-signaling comprises configuration parameters of an SRAP layer corresponding to the second bearer.

In one subembodiment of the embodiment, the first sub-signaling comprises an identity of the first relay associated with the second bearer.

In one subembodiment of the embodiment, the first sub-signaling comprises configuration parameters of a sidelink RLC entity corresponding to the third bearer.

In one subembodiment of the embodiment, the first sub-signaling indicates a radio link associated with the third bearer.

In one subembodiment of the embodiment, the first sub-signaling comprises configuration parameters of a MAC corresponding to the third bearer.

In one subembodiment of the embodiment, the first sub-signaling comprises configuration parameters of an SRAP layer corresponding to the third bearer.

In one subembodiment of the embodiment, the first sub-signaling comprises an identity of the first relay associated with the third bearer.

In one subembodiment of the above embodiment, the target bearer is the second bearer.

In one embodiment, the first node U11, as a response to receiving a second sub-signaling, starts a first timer, suspends a third bearer, and configures the second bearer.

In one subembodiment of the above embodiment, the target bearer is the second bearer.

In one embodiment, the third bearer is associated with the first cell group.

In one subembodiment of the above embodiment, the target bearer is the second bearer.

In one subembodiment of the above embodiment, the meaning of the phrase of the third bearer being associated with the first cell group is: the third bearer is a bearer between the first node and the first cell group.

In one subembodiment of the above embodiment, the meaning of the phrase of the third bearer being associated with the first cell group is: the third bearer terminates at the first node and the first cell group.

In one subembodiment of the above embodiment, the meaning of the phrase of the third bearer being associated with the first cell group is: the third bearer terminates at the first node and a base station of the first cell group.

In one subembodiment of the above embodiment, the meaning of the phrase of the third bearer being associated with the first cell group is: PDCP entities corresponding to the third bearer are respectively at the first node and the first cell group.

In one subembodiment of the above embodiment, the meaning of the phrase of the third bearer being associated with the first cell group is: RLC entities corresponding to the third bearer are respectively at the first node and the first cell group.

In one subembodiment of the above embodiment, the meaning of the phrase of the third bearer being associated with the first cell group is: a MAC corresponding to or used by or mapped by the third bearer is for the first cell group.

In one subembodiment of the above embodiment, the meaning of the phrase of the third bearer being associated with the first cell group is: the third bearer is used to transmit a PDCP PDU between the first node and the first cell group.

In one subembodiment of the above embodiment, the meaning of the phrase of the third bearer being associated with the first cell group is: the third bearer is used to transmit a PDCP SDU between the first node and the first cell group.

In one subembodiment of the above embodiment, the meaning of the phrase of the third bearer being associated with the first cell group is: the third bearer is used to transmit an RLC PDU between the first node and the first cell group.

In one subembodiment of the above embodiment, the meaning of the phrase of the third bearer being associated with the first cell group is: the third bearer is used to transmit a MAC PDU between the first node and the first cell group.

In one subembodiment of the above embodiment, the meaning of the phrase of the third bearer being associated with the first cell group is: the third bearer is used to transmit data for the first cell group.

In one subembodiment of the above embodiment, the meaning of the phrase of the third bearer being associated with the first cell group is: at least SRB1 between the first node and the first cell group uses the third bearer.

In one subembodiment of the above embodiment, the meaning of the phrase of the third bearer being associated with the first cell group is: there exists a mapping relation between at least SRB1 between the first node and the first cell group as well as the third bearer.

In one subembodiment of the above embodiment, the meaning of the phrase of the third bearer being associated with the first cell group is: the third bearer is a bearer between the first node and the first relay, and the first relay is a relay between the first node and the first cell group.

In one subembodiment of the above embodiment, the meaning of the phrase of the third bearer being associated with the first cell group is: the third bearer is a bearer between the first node and the first relay, and the first relay forwards data between the first node and the first cell group.

In one subembodiment of the above embodiment, the meaning of the phrase of the third bearer being associated with the first cell group is: the third bearer is an RLC bearer between the first node and the first relay, and the first relay is a relay between the first node and the first cell group.

In one subembodiment of the above embodiment, the meaning of the phrase of the third bearer being associated with the first cell group is: the third bearer is an RLC bearer between the first node and the first relay, and the first relay forwards data between the first node and the first cell group.

In one subembodiment of the above embodiment, the meaning of the phrase of the third bearer being associated with the first cell group is: the third bearer is a sidelink radio link between the first node and the first relay, and the first relay is a relay between the first node and the first cell group.

In one subembodiment of the above embodiment, the meaning of the phrase of the third bearer being associated with the first cell group is: the first cell group is an anchor of the first node U11 or an anchor of SRB1 of the first node U11.

In one subembodiment of the above embodiment, the meaning of the phrase of the third bearer being associated with the first cell group is: the third bearer is a sidelink radio link between the first node and the first relay, and the first relay forwards data between the first node and the first cell group.

In one subembodiment of the above embodiment, the meaning of the phrase of the third bearer being associated with the first cell group is: the third bearer is an RLC bearer between the first node and the first relay, the third bearer is used to bear at least SRB1, and the at least SRB1 is an SRB between the first node and the first cell group.

In one embodiment, the second sub-signaling comprises a first field, the first field is reconfigurationWithSync, the first field is used to indicate a path switch for the third bearer, and the first timer is a timer other than T304; the behavior of detecting a target bearer failure comprises detecting an expiration of the first timer.

In one subembodiment of the embodiment, conditions of the first target bearer failure comprise the first timer expiration.

In one embodiment, the second sub-signaling indicates that the third bearer is transited to the second bearer.

In one embodiment, the second sub-signaling indicates stopping using the third bearer, and starts using the second bearer.

In one embodiment, the phrase of a path switch for the third bearer comprises: activating the third bearer.

In one embodiment, the phrase of a path switch for the third bearer comprises: suspending the second bearer.

In one embodiment, the phrase of a path switch for the third bearer comprises: releasing the second bearer.

In one embodiment, the phrase of a path switch for the third bearer comprises: re-establishing the second bearer.

In one embodiment, the first operation set comprises: activating the third bearer; the first operation set comprises one of suspending the second bearer, releasing the second bearer or re-establishing the second bearer.

### Embodiment 7

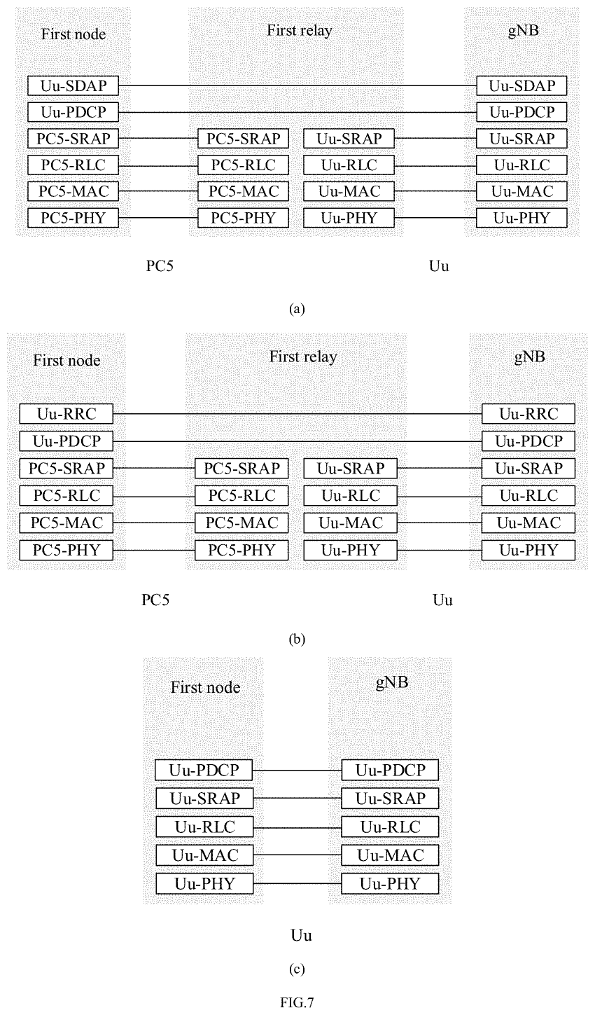

Embodiment 7 illustrates a schematic diagram of a protocol stack of relay communications according to one embodiment of the present application, as shown in FIG. 7.

FIG. 7 is divided into three sub-figures (a), (b) and (c).

The protocol stack shown in FIG. 7 is applicable to L2 U2N relay communications, and embodiment 7 is based on embodiment 3.

in FIG. 7 corresponds to the user-plane interface protocol stack in L2 U2N relay communications; (b) in FIG. 7 corresponds to the control-plane interface protocol stack in L2 U2N relay communications.

In one embodiment, a first relay is a relay when the first node using an indirect path.

In one embodiment, a first relay is an L2 U2N relay UE between the first node and the first cell group.

In one embodiment, a gNB in FIG. 7 is a gNB in the first cell group.

In one embodiment, a gNB in FIG. 7 is a gNB corresponding to the first cell group.

In one embodiment, a gNB in FIG. 7 is a gNB corresponding to a PCell of the first cell group.

In one embodiment, a gNB in FIG. 7 belongs to the first cell group.

In embodiment 7, a PC5 is an interface between the first node and the first relay, and a protocol entity of {PC5-SRAP, PC5-RLC, PC5-MAC, PC5-PHY} related to a PC5 interface terminates at the first node and the first relay; a Uu interface is an interface between a UE and a gNB, and a protocol entity of a Uu interface respectively terminates at the UE and the gNB.

In one embodiment, the first relay is a U2N relay UE, before executing the first signaling, the first relay provides an L2 U2N relay services to the first node.

In one embodiment, both the first node and the first relay are UEs.

In one embodiment, the gNB in FIG. 7 corresponds to the second node in the present application.

In one embodiment, a protocol entity of {Uu-SRAP, Uu-RLC, Uu-MAC, Uu-PHY} of a Uu interface terminates at the first relay and a gNB.

In one embodiment, in (a), a protocol entity of {Uu-SRAP, Uu-PDCP} of a Uu interface terminates at the first node and a gNB, an SDAP PDU and a PDCP PDU of the first node is forwarded through the first relay, but the first relay does not modify the SDAP PDU and the PDCP PDU of the first node, that is, an SDAP PDU and a PDCP PDU transmitted by the first node to a gNB are transparent to the first relay.

In one embodiment, in (b), a protocol entity of {Uu-RRC, Uu-PDCP} of a Uu interface terminates at the first node and a gNB, an RRC PDU and a PDCP PDU of the first node are forwarded through the first relay, but the first relay does not modify the RRC PDU and the PDCP PDU transmitted by the first node, that is, an RRC PDU and a PDCP PDU transmitted by the first node to a gNB are transparent to the first relay.

In one embodiment, in (a), a PC5-SRAP corresponds to an SRAP 357 in FIG. 3, a PC5-RLC corresponds to an RLC 353 in FIG. 3, a PC5-MAC corresponds to a MAC 352 in FIG. 3, and a PC5-PHY corresponds to a PHY 351 in FIG. 3.

In one embodiment, in (a), a Uu-SDAP corresponds to an SDAP 356 in FIG. 3, and a Uu-PDCP corresponds to a PDCP 354 in FIG. 3.

In one embodiment, in (b), a PC5-SRAP corresponds to an SRAP 307 in FIG. 3, a PC5-RLC corresponds to an RLC 303 in FIG. 3, a PC5-MAC corresponds to a MAC 302 in FIG. 3, and a PC5-PHY corresponds to a PHY 301 in FIG. 3.

In one embodiment, in (b), a Uu-RRC corresponds to an RRC 306 in FIG. 3, and a Uu-PDCP corresponds to a PDCP 304 in FIG. 3.

In one embodiment, a cell of the gNB in FIG. 7 is a PCell of the first relay, and the first relay is in an RRC_CONTECTED state.

In one embodiment, the first cell group is an MCG of the first relay.

In one embodiment, a PC5-SRAP is used only for a specific RB or message or data.

In one subembodiment of the embodiment, when the first relay forwards system information of gNB, a PC5-SRAP layer is not used.

In one embodiment, in FIG. 7, communications between the first node and the gNB use an indirect path.

In one embodiment, in FIG. 7, communications between the first node and the gNB use a direct path.

In one embodiment, in FIG. 7, communications between the first node and the gNB use a direct path and an indirect path at the same time.

In one embodiment, the first signaling is generated by a Uu-RRC of the gNB in FIG. 7(b), and is received by a Uu-RRC of the first node.

In one embodiment, the first signaling is transparent to the first relay.

In one embodiment, the first information is forwarded to a gNB from the first relay.

In one embodiment, the first information is directly transmitted to a gNB without being forwarded through relay.

In one embodiment, when using an indirect path, a Uu-PDCP of the first node is associated with a PC5-RLC, or is associated with a PC5-RLC through a PC5-SRAP.

In one embodiment, when using a direct path, the first node will establish a Uu-RLC, and a Uu-PDCP of the first node is associated with a Uu-RLC.

In one subembodiment of the embodiment, after switching to the direct path, the first node releases a PC5-RLC.

In one subembodiment of the embodiment, after switching to the direct path, the first node releases a PC5-SRAP.

In one subembodiment of the embodiment, after switching to the direct path, the first node releases a PC5-MAC and a PC5-PHY.

In one subembodiment of the embodiment, after switching to the direct path, the first node does not use a PC5-SRAP.

In one subembodiment of the embodiment, after switching to the direct path, there does not exist other protocol layers between a Uu-PDCP and a Uu-RLC of the first node.

In one embodiment, the second bearer is a radio link between the first node and the first relay in (a) and/or (b) in FIG. 7.

In one embodiment, the second bearer is a sidelink radio link between the first node and the first relay in (a) and/or (b) in FIG. 7.

In one embodiment, the second bearer is a sidelink RLC bearer between the first node and the first relay in (a) and/or (b) in FIG. 7.

In one embodiment, the second bearer is a transport channel between the first node and the first relay in (a) and/or (b) in FIG. 7.

In one embodiment, the second bearer is a logical channel between the first node and the first relay in (a) and/or (b) in FIG. 7.

In one embodiment, the second bearer is a physical channel between the first node and the first relay in (a) and/or (b) in FIG. 7.

In one embodiment, the second bearer is a direct unicast link between the first node and the first relay in (a) and/or (b) in FIG. 7.

In one embodiment, the second bearer is an interface between PC5-SRAP entities between the first node and the first relay in (a) and/or (b) in FIG. 7.

In one embodiment, the second bearer is a PC5 interface between the first node and the first relay in (a) and/or (b) in FIG. 7.

In one embodiment, (c) in FIG. 7 is a protocol stack of communications between the first node and the gNB when relay is not used.

In one embodiment, (c) in FIG. 7 is a protocol stack of communications between the first node and the gNB when direct path is used and relay is not used.

In one embodiment, the first bearer is a radio bearer between the first node and a gNB in (c) in FIG. 7.

In one embodiment, the first bearer is a radio link between the first node and a gNB in (c) in FIG. 7.

In one embodiment, the first bearer is a RLC bearer between the first node and a gNB in (c) in FIG. 7.

In one embodiment, the first bearer is a channel between the first node and a gNB in (c) in FIG. 7.

In one embodiment, the first bearer is a logical channel between the first node and a gNB in (c) in FIG. 7.

In one embodiment, the first bearer is a physical channel between the first node and a gNB in (c) in FIG. 7.

In one embodiment, the first bearer is a Uu interface between the first node and gNB in (c) in FIG. 7.

### Embodiment 8

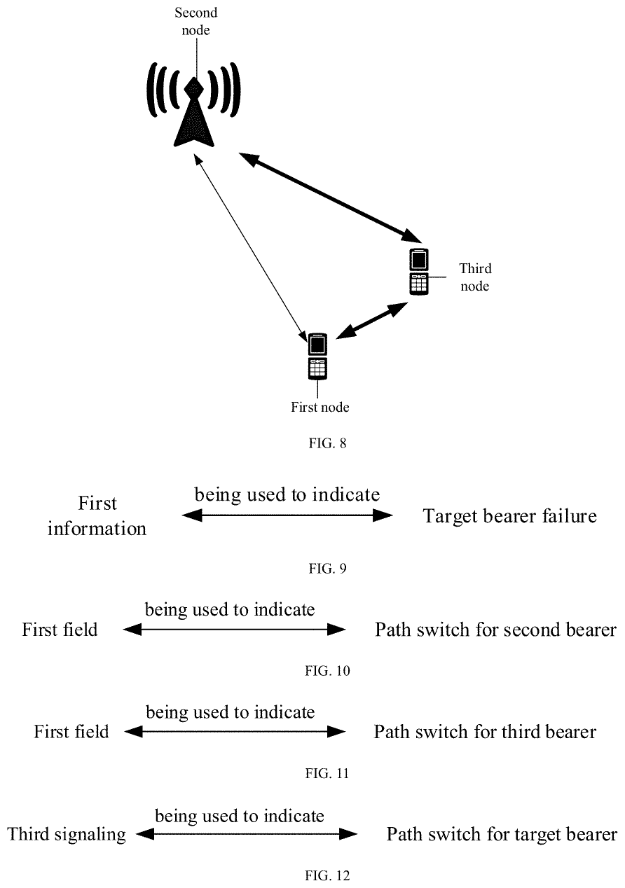

Embodiment 8 illustrates a schematic diagram of topology according to one embodiment of the present application, as shown in FIG. 8.

The topology in embodiment 8 and the definitions of a first-type bearer and a second-type bearer are applicable to other embodiments comprising embodiment 5.

A first node in embodiment 8 corresponds to the first node in the present application.

In one embodiment, a second node in embodiment 8 corresponds to a first cell group in the present application.

In one embodiment, a second node in embodiment 8 corresponds to a PCell of a first cell group in the present application.

In one embodiment, a second node in embodiment 8 corresponds to a gNB corresponding to a first cell group in the present application.

In one embodiment, a second node in embodiment 8 corresponds to a PCell of the first node in the present application.

In one embodiment, a second node in embodiment 8 corresponds to a transmitting point of an MCG of the first node in the present application.

In one embodiment, a third node in embodiment 8 is a relay node of the first node.

In one embodiment, a third node in embodiment 8 is the first relay.

In one embodiment, a third node in embodiment 8 is the second relay.

In one embodiment, a third node in embodiment 8 is the third relay, the third relay is an L2 U2N relay UE, the third relay is a node other than the first relay and a second relay, and the fourth bearer is associated with the third relay.

In one subembodiment of the embodiment, the fourth bearer is an indirect path, and data of the fourth bearer is forwarded through the third relay.

In one subembodiment of the embodiment, data of the fourth bearer is forwarded through the third relay.

In one subembodiment of the embodiment, the fourth bearer is or comprises a sidelink radio link between the first node and the third relay.

In one subembodiment of the embodiment, the fourth bearer is or comprises a sidelink RLC bearer between the first node and the third relay.

In one subembodiment of the embodiment, the fourth bearer is or comprises a channel between the first node and the third relay.

In one subembodiment of the embodiment, the fourth bearer is or comprises a direct link between the first node and the third relay.

In one embodiment, a third node in embodiment 8 is a relay node from the first node to the second node.

In one embodiment, a third node in embodiment 8 is an L2 U2N relay UE of the first node.

In one embodiment, a third node in embodiment 8 is an SCell of the first cell group.

In one embodiment, a third node in embodiment 8 is a transmitting point of the first cell group.

In one embodiment, a third node in embodiment 8 is a cell other than a PCell.

In one embodiment, a third node in embodiment 8 is a neighbor cell.

In one embodiment, a third node in embodiment 8 is a relay of the first cell group.

In one embodiment, a third node in embodiment 8 is a node of TN.

In one embodiment, a third node in embodiment 8 is a node of NTN.

In one embodiment, the first bearer refers to a bearer between the first node and the second node.

In one embodiment, the first bearer refers to a radio link between the first node and the second node.

In one embodiment, the first bearer refers to an RLC bearer between the first node and the second node.

In one embodiment, the first bearer refers to a communication link between the first node and the second node.

In one embodiment, the first bearer refers to a channel between the first node and the second node.

In one embodiment, the first bearer refers to a communication interface between the first node and the second node.

In one embodiment, the first bearer is unrelated to a relay.

In one embodiment, the second relay is related to a relay.

In one embodiment, the second bearer is a bearer between the first node and the third node, and the third node is the first relay.

In one embodiment, the second bearer is a sidelink radio link between the first node and the third node, and the third node is the first relay.

In one embodiment, the second bearer is a communication link between the first node and the third node, and the third node is the first relay.

In one embodiment, the second bearer is a communication interface between the first node and the third node, and the third node is the first relay.

In one embodiment, the second bearer is a sidelink RLC bearer between the first node and the third node, and the third node is the first relay.

In one embodiment, the second bearer is a channel between the first node and the third node, and the third node is the first relay.

In one embodiment, the second bearer is a bearer through the third node and between the first node and the second node, and the third node is the first relay.

In one embodiment, the second bearer is a communication link through the third node and between the first node and the second node, and the third node is the first relay.

In one embodiment, the second bearer comprises a sidelink RLC bearer between the first node and the third node and an RLC bearer between the third node and the second node, the third node is the first relay.

In one embodiment, the second bearer comprises a channel between the first node and the third node and a channel between the third node and the second node, the third node is the first relay.

In one embodiment, the second bearer comprises a sidelink radio link between the first node and the third node and a radio link between the third node and the second node, the third node is the first relay.

In one embodiment, the first bearer is a direct path.

In one embodiment, a link between the first node and the second node and not forwarded through the third node is a direct path.

In one embodiment, a link between the first node and the second node and forwarded through the third node is an indirect path.

In one embodiment, a direct path is a method or transmission path that the first node is in communications with the second node not through the third node.

In one embodiment, an indirect path is a method or transmission path that the first node is in communications with the second node through the third node.

In one embodiment, the first bearer is or belongs to a direct path.

In one embodiment, the second bearer is an indirect path.

In one embodiment, both the first bearer and the second bearer are for the first node.

In one embodiment, both the first bearer and the second bearer are for data transmission of the first node and the second node.

In one embodiment, the second bearer comprises transmission paths between the first node and the third node as well as between the third node and the second node.

In one embodiment, the second bearer comprises a direct path between the first node and the third node.

In one embodiment, the second bearer comprises a PC5 direct path between the first node and the third node.

In one embodiment, the third bearer is a bearer between the first node and the third node, and the third node is the second relay.

In one embodiment, the third bearer is a sidelink radio link between the first node and the third node, and the third node is the second relay.

In one embodiment, the third bearer is a communication link between the first node and the third node, and the third node is the second relay.

In one embodiment, the third bearer is a communication interface between the first node and the third node, and the third node is the second relay.

In one embodiment, the third bearer is a sidelink RLC bearer between the first node and the third node, and the third node is the second relay.

In one embodiment, the third bearer is a channel between the first node and the third node, and the third node is the second relay.

In one embodiment, the third bearer is a bearer through the third node and between the first node and the second node, and the third node is the second relay.

In one embodiment, the third bearer is a communication link through the third node and between the first node and the second node, the third node is the second relay.

In one embodiment, the third bearer comprises a sidelink RLC bearer between the first node and the third node and an RLC bearer between the third node and the second node, and the third node is the second relay.

In one embodiment, the third bearer comprises a channel between the first node and the third node and a channel between the third node and the second node, and the third node is the second relay.

In one embodiment, the third bearer comprises a sidelink radio link between the first node and the third node and a radio link between the third node and the second node, and the third node is the second relay.

In one embodiment, the fourth bearer is a bearer between the first node and the third node, and the third node is the third relay.

In one embodiment, the fourth bearer is a sidelink radio link between the first node and the third node, and the third node is the third relay.

In one embodiment, the fourth bearer is a communication link between the first node and the third node, and the third node is the third relay.

In one embodiment, the fourth bearer is a communication interface between the first node and the third node, and the third node is the third relay.

In one embodiment, the fourth bearer is a sidelink RLC bearer between the first node and the third node, and the third node is the third relay.

In one embodiment, the fourth bearer is a channel between the first node and the third node, and the third node is the third relay.

In one embodiment, the fourth bearer is a bearer through the third node and between the first node and the second node, and the third node is the third relay.

In one embodiment, the fourth bearer is a communication link through the third node and between the first node and the second node, and the third node is the third relay.

In one embodiment, the fourth bearer comprises a sidelink RLC bearer between the first node and the third node and an RLC bearer between the third node and the second node, and the third node is the third relay.

In one embodiment, the fourth bearer comprises a channel between the first node and the third node and a channel between the third node and the second node, and the third node is the third relay.

In one embodiment, the fourth bearer comprises a sidelink radio link between the first node and the third node and a radio link between the third node and the second node, and the third node is the third relay.

### Embodiment 9

Embodiment 9 illustrates a schematic diagram of first information being used to indicate a first bearer failure according to one embodiment of the present application, as shown in FIG. 9.

In one embodiment, the first information explicitly indicates the first bearer failure.

In one embodiment, the first information implicitly indicates the first bearer failure.

In one embodiment, the first information explicitly indicates a cause of the first bearer failure.

In one embodiment, the first information explicitly indicates a type of the first bearer failure.

In one embodiment, a transmission of the first information indicates the first bearer failure.

In one embodiment, the first information is one or multiple fields of an RRC message.

In one embodiment, the first information is one or multiple cells of an RRC message.

In one embodiment, the first information indicates an identity of the first bearer.

In one embodiment, the first information indicates a logical channel identity of the first bearer.

In one embodiment, the first information indicates a cell group identity of the first bearer.

In one embodiment, the first information indicates a cell identity of the first bearer.

In one embodiment, the first information indicates a time of the first bearer failure.

In one embodiment, the first information indicates whether the first bearer is the first bearer.

In one embodiment, the first information indicates whether the first bearer is the second bearer.

In one embodiment, resources occupied by the first information indicates whether the first bearer is the first bearer or the second bearer.

In one embodiment, a bearer occupied by the first information indicates whether the first bearer is the first bearer or the second bearer.

In one embodiment, when the first information is transmitted on the first bearer, the first information indicates the second bearer failure.

In one embodiment, when the first information is transmitted on the second bearer, the first information indicates the first bearer failure.

In one embodiment, the first information indicates an identity of a relay of the first node.

In one subembodiment of the above embodiment, the first bearer is the first bearer.

In one subembodiment of the above embodiment, the first bearer is the second bearer.

In one embodiment, the first information is always transmitted on a first bearer.

In one embodiment, the first information is always transmitted on a direct path.

In one embodiment, the first information does not use a relay for forwarding.

In one embodiment, the first information is or comprises at least partial fields in SidelinkUEInformation.

In one embodiment, when the first bearer is the first bearer, the first information indicates an rlc-failure.

In one embodiment, when the first bearer is the second bearer, the first information indicates an sl-rlc-failure.

In one embodiment, the first information comprises a failureType field.

In one embodiment, the first information indicates a logical channel identity corresponding to the first bearer.

In one embodiment, the first information indicates a temporary identity of the first node, and the temporary identity is an identity in an SRAP layer of the first node.

In one subembodiment of the above embodiment, the first bearer is the first bearer.

In one subembodiment of the above embodiment, the first bearer is the second bearer.

In one embodiment, the first information indicates a bearer failure, and indicates whether the failed bearer is the first bearer or the second bearer.

### Embodiment 10

Embodiment 10 illustrates a schematic diagram of a first field being used to indicate a path switch for a second bearer according to one embodiment of the present application, as shown in FIG. 10.

In one embodiment, the first field comprises parameters of path switch for the second bearer.

In one embodiment, the first field explicitly indicates a path switch for the second bearer.

In one embodiment, a sl-PathSwitchConfig field comprised in the first field is used to indicate a path switch for the second bearer.

In one embodiment, the first field comprises an identity of a destination L2 U2N relay UE.

In one subembodiment of the embodiment, the destination L2 U2N relay UE is an L2 U2N relay UE other than the first relay.

In one embodiment, a sidelink RLC bearer configuration comprised in the first field is used for a path switch for the second bearer.

In one subembodiment of the embodiment, the sidelink RLC bearer configuration comprised in the first field is a sidelink RLC bearer configuration other than the second bearer.

In one subembodiment of the embodiment, the sidelink RLC bearer configuration comprised in the first field is a sidelink RLC bearer configuration other than a sidelink RLC bearer associated with the second bearer.

In one subembodiment of the embodiment, the sidelink RLC bearer comprised in the first field is or comprises configuration parameters of an RLC entity corresponding to the sidelink RLC bearer comprised in the first field.

In one embodiment, the second bearer is an indirect path.

In one embodiment, the meaning of the phrase of a path switch for a second bearer comprises: switching a path associated with the second bearer.

In one embodiment, the meaning of the phrase of a path switch for a second bearer comprises: path switch is related to the second bearer.

In one embodiment, the meaning of the phrase of a path switch for a second bearer comprises: path switch comprises executing at least one operation in a third operation set for the second bearer; the third operation set comprises stopping, suspending, de-activating, and releasing.

In one embodiment, the meaning of the phrase of a path switch for a second bearer comprises: path switch comprises switching the second bearer to another bearer, and the another bearer also belongs to an indirect path.

In one embodiment, the meaning of the phrase of a path switch for a second bearer comprises: executing a transition from a direct path to an indirect path.

In one embodiment, the meaning of the phrase of a path switch for a second bearer comprises: executing a transition from an indirect path to a direct path.

In one embodiment, the meaning of the phrase of a path switch for a second bearer comprises: executing a transition from an indirect path to an indirect path.

In one embodiment, the meaning of the phrase of a path switch for a second bearer comprises: stopping using the second bearer to transmit data for the first cell group, and starting using a bearer other than the second bearer to transmit data for the first cell group.

In one subembodiment of the embodiment, the bearer other than the second bearer is a sidelink radio link.

In one subembodiment of the embodiment, the bearer other than the second bearer is a sidelink RLC bearer.

In one subembodiment of the embodiment, the bearer other than the second bearer is a sidelink channel.

In one subembodiment of the embodiment, the bearer other than the second bearer is a direct link.

In one subembodiment of the embodiment, the behavior of stopping using the second bearer comprises releasing the second bearer.

In one subembodiment of the embodiment, the behavior of stopping using the second bearer comprises suspending the second bearer.

In one subembodiment of the embodiment, the behavior of stopping using the second bearer comprises de-activating the second bearer.

In one subembodiment of the embodiment, the behavior of releasing using the second bearer comprises removing a mapping relation between the second bearer and the first cell group or a radio bearer of the first cell group.

In one subembodiment of the embodiment, a relay associated with the bearer other than the second bearer is a fourth relay, and the fourth relay is different from the first relay; the fourth relay is an L2 U2N relay UE; the behavior of stopping using the second bearer to transmit data for the first cell group, and starting using a bearer other than the second bearer to transmit data for the first cell group comprises, selecting the fourth bearer as a U2N relay of the first node.

In one subembodiment of the embodiment, a relay associated with the bearer other than the second bearer is a fourth relay, and the fourth relay is different from the first relay; the fourth relay is an L2 U2N relay UE; the behavior of stopping using the second bearer to transmit data for the first cell group, and starting using a bearer other than the second bearer to transmit data for the first cell group comprises, stopping using the first relay.

In one subembodiment of the embodiment, a relay associated with the bearer other than the second bearer is a fourth relay, and the fourth relay is different from the first relay; the fourth relay is an L2 U2N relay UE; the behavior of stopping using the second bearer to transmit data for the first cell group, and starting using a bearer other than the second bearer to transmit data for the first cell group comprises, assuming that the fourth relay is a destination L2 U2N relay UE.

In one embodiment, the meaning of the phrase of a path switch for a second bearer comprises: stopping using the second bearer to transmit data for the first cell group, and starting using a bearer other than the second bearer to transmit data for the first cell group.

In one subembodiment of the embodiment, the bearer other than the second bearer is a sidelink radio link.

In one subembodiment of the embodiment, the bearer other than the second bearer is a sidelink RLC bearer.

In one subembodiment of the embodiment, the bearer other than the second bearer is a sidelink channel.

In one subembodiment of the embodiment, the bearer other than the second bearer is a direct link.

In one embodiment, the meaning of the phrase of a path switch for a second bearer comprises: stopping using the second bearer to transmit data of a first radio bearer, and starting using a bearer other than the second bearer to transmit data of the first radio bearer.

In one subembodiment of the embodiment, the bearer other than the second bearer is a sidelink radio link.

In one subembodiment of the embodiment, the bearer other than the second bearer is a sidelink RLC bearer.

In one subembodiment of the embodiment, the bearer other than the second bearer is a sidelink channel.

In one subembodiment of the embodiment, the bearer other than the second bearer is a direct link.

In one subembodiment of the embodiment, the first radio bearer is a radio bearer.

In one subembodiment of the embodiment, the first radio bearer is or comprises SRB1.

In one subembodiment of the embodiment, the first radio bearer is or comprises a DRB.

In one subembodiment of the embodiment, the first radio bearer is or comprises an MRB.

In one subembodiment of the embodiment, the behavior of stopping using the second bearer to transmit data of a first radio bearer comprises releasing the second bearer.

In one subembodiment of the embodiment, the behavior of stopping using the second bearer to transmit data of a first radio bearer comprises suspending the second bearer.

In one subembodiment of the embodiment, the behavior of stopping using the second bearer to transmit data of a first radio bearer comprises de-activating the second bearer.

In one subembodiment of the embodiment, the behavior of stopping using the second bearer to transmit data of a first radio bearer comprises releasing a mapping relation between the second bearer and the first radio bearer.

In one subembodiment of the embodiment, the behavior of starting using a bearer other than the second bearer to transmit data of the first radio bearer comprises: activating the bearer other than the second bearer.

In one subembodiment of the embodiment, the behavior of starting using a bearer other than the second bearer to transmit data of the first radio bearer comprises: establishing a mapping relation between the bearer other the second bearer and the first radio bearer.

In one subembodiment of the embodiment, a relay associated with the bearer other than the second bearer is a fourth relay, and the fourth relay is different from the first relay; the fourth relay is an L2 U2N relay UE; the behavior of stopping using the second bearer to transmit data of a first radio bearer, and starting using a bearer other than the second bearer to transmit data of the first radio bearer comprises, selecting the fourth relay as a U2N relay of the first node.

In one subembodiment of the embodiment, a relay associated with the bearer other than the second bearer is a fourth relay, and the fourth relay is different from the first relay; the fourth relay is an L2 U2N relay UE; the behavior of stopping using the second bearer to transmit data of a first radio bearer, and starting using a bearer other than the second bearer to transmit data of the first radio bearer comprises, stopping using the first relay.

In one subembodiment of the embodiment, a relay associated with the bearer other than the second bearer is a fourth relay, and the fourth relay is different from the first relay; the fourth relay is an L2 U2N relay UE; the behavior of stopping using the second bearer to transmit data of a first radio bearer, and starting using a bearer other than the second bearer to transmit data of the first radio bearer comprises, assuming that the fourth relay is a destination L2 U2N relay UE.

### Embodiment 11

Embodiment 11 illustrates a schematic diagram of a first field being used to indicate a path switch of a third bearer according to one embodiment of the present application, as shown in FIG. 11.

In one embodiment, the first field comprises parameters of a path switch for the third bearer.

In one embodiment, the first field explicitly indicates a path switch for the third bearer.

In one embodiment, a sl-PathSwitchConfig field comprised in the first field is used to indicate a path switch for the third bearer.

In one embodiment, the first field indicates switching the third bearer to the second bearer.

In one subembodiment of the embodiment, the behavior of the first field indicating switching the third bearer to the second bearer comprises: starting using the second bearer, and stopping using the third bearer.

In one subembodiment of the embodiment, the behavior of the first field indicating switching the third bearer to the second bearer comprises: activating using the second bearer, and deactivating using the third bearer.

In one subembodiment of the embodiment, the behavior of the first field indicating switching the third bearer to the second bearer comprises: continuing the second bearer, and suspending using the third bearer.

In one embodiment, the first field comprises an identity of a destination L2 U2N relay UE.

In one subembodiment of the embodiment, the destination L2 U2N relay UE is an L2 U2N relay UE other than the first relay.

In one subembodiment of the embodiment, the destination L2 U2N relay UE is the first relay.

In one embodiment, a sidelink RLC bearer configuration comprised in the first field is used for a path switch for the third bearer.

In one subembodiment of the embodiment, the sidelink RLC bearer configuration comprised in the first field is a sidelink RLC bearer configuration other than the third bearer.

In one subembodiment of the embodiment, the sidelink RLC bearer configuration comprised in the first field is a sidelink RLC bearer configuration other than a sidelink RLC bearer associated with the third bearer.

In one subembodiment of the embodiment, the sidelink RLC bearer comprised in the first field is or comprises configuration parameters of an RLC entity corresponding to the sidelink RLC bearer comprised in the first field.

In one embodiment, the third bearer is an indirect path.

In one embodiment, the meaning of the phrase of a path switch for a third bearer comprises: switching a path associated with the third bearer.

In one embodiment, the meaning of the phrase of a path switch for a third bearer comprises: a path switch is related to the third bearer.

In one embodiment, the meaning of the phrase of a path switch for a third bearer comprises: path switch comprises executing at least one operation in a third operation set for the third bearer; the third operation set comprises stopping, suspending, de-activating, and releasing.

In one embodiment, the meaning of the phrase of a path switch for a third bearer comprises: path switch comprises switching the third bearer to another bearer, and the another bearer also belongs to an indirect path.

In one embodiment, the meaning of the phrase of a path switch for a third bearer comprises: executing a transition from a direct path to an indirect path.

In one embodiment, the meaning of the phrase of a path switch for a third bearer comprises: executing a transition from an indirect path to a direct path.

In one embodiment, the meaning of the phrase of a path switch for a third bearer comprises: executing a transition from an indirect path to an indirect path.

In one embodiment, the meaning of the phrase of a path switch for a third bearer comprises: stopping using the third bearer to transmit data for the first cell group, and starting using a bearer other than the third bearer to transmit data for the first cell group.

In one subembodiment of the embodiment, the bearer other than the third bearer is a sidelink radio link.

In one subembodiment of the embodiment, the bearer other than the third bearer is a sidelink RLC bearer.

In one subembodiment of the embodiment, the bearer other than the third bearer is a sidelink channel.

In one subembodiment of the embodiment, the bearer other than the third bearer is a direct link.

In one subembodiment of the embodiment, the behavior of stopping using the third bearer comprises releasing the third bearer.

In one subembodiment of the embodiment, the behavior of stopping using the third bearer comprises suspending the third bearer.

In one subembodiment of the embodiment, the behavior of stopping using the third bearer comprises de-activating the third bearer.

In one subembodiment of the embodiment, the behavior of releasing using the third bearer comprises removing a mapping relation between the third bearer and the first cell group or a radio bearer of the first cell group.

In one subembodiment of the embodiment, a relay associated with the bearer other than the third bearer is a second relay, and the second relay is different from the first relay; the second relay is an L2 U2N relay UE; the behavior of stopping using the third bearer to transmit data for the first cell group, and starting using a bearer other than the third bearer to transmit data for the first cell group comprises, selecting the second relay as a U2N relay of the first node.

In one subembodiment of the embodiment, a relay associated with the bearer other than the third bearer is a second relay, and the second relay is different from the first relay; the second relay is an L2 U2N relay UE; the behavior of stopping using the third bearer to transmit data for the first cell group, and starting using a bearer other than the third bearer to transmit data for the first cell group comprises, stopping using the first relay.

In one subembodiment of the embodiment, a relay associated with the bearer other than the third bearer is a second relay, and the second relay is different from the first relay; the second relay is an L2 U2N relay UE; the behavior of stopping using the third bearer to transmit data for the first cell group, and starting using a bearer other than the third bearer to transmit data for the first cell group comprises, assuming that the second relay is a destination L2 U2N relay UE.

In one subembodiment of the embodiment, the bearer other than the third bearer is the second bearer.

In one embodiment, the meaning of the phrase of a path switch for a third bearer comprises: stopping using the third bearer to transmit data for the first cell group, and starting using a bearer other than the third bearer to transmit data for the first cell group.

In one subembodiment of the embodiment, the bearer other than the third bearer is a sidelink radio link.

In one subembodiment of the embodiment, the bearer other than the third bearer is a sidelink RLC bearer.

In one subembodiment of the embodiment, the bearer other than the third bearer is a sidelink channel.

In one subembodiment of the embodiment, the bearer other than the third bearer is a direct link.

In one subembodiment of the embodiment, the bearer other than the third bearer is the second bearer.

In one embodiment, the meaning of the phrase of a path switch for a third bearer comprises: stopping using the third bearer to transmit data of a first radio bearer, and starting using a bearer other than the third bearer to transmit data of the first radio bearer.

In one subembodiment of the embodiment, the bearer other than the third bearer is a sidelink radio link.

In one subembodiment of the embodiment, the bearer other than the third bearer is a sidelink RLC bearer.

In one subembodiment of the embodiment, the bearer other than the third bearer is a sidelink channel.

In one subembodiment of the embodiment, the bearer other than the third bearer is a direct link.

In one subembodiment of the embodiment, the first radio bearer is a radio bearer.

In one subembodiment of the embodiment, the first radio bearer is or comprises SRB1.

In one subembodiment of the embodiment, the first radio bearer is or comprises a DRB.

In one subembodiment of the embodiment, the first radio bearer is or comprises an MRB.

In one subembodiment of the embodiment, the behavior of stopping using the third bearer to transmit data of a first radio bearer comprises releasing the third bearer.

In one subembodiment of the embodiment, the behavior of stopping using the third bearer to transmit data of a first radio bearer comprises suspending the third bearer.

In one subembodiment of the embodiment, the behavior of stopping using the third bearer to transmit data of a first radio bearer comprises de-activating the third bearer.

In one subembodiment of the embodiment, the behavior of stopping using the third bearer to transmit data of a first radio bearer comprises releasing a mapping relation between the third bearer and the first radio bearer.

In one subembodiment of the embodiment, the behavior of starting using a bearer other than the third bearer to transmit data of the first radio bearer comprises: activating the bearer other than the third bearer.

In one subembodiment of the embodiment, the behavior of starting using a bearer other than the third bearer to transmit data of the first radio bearer comprises: establishing a mapping relation between the bearer other the third bearer and the first radio bearer.

In one subembodiment of the embodiment, a relay associated with the bearer other than the third bearer is a second relay, and the second relay is different from the first relay; the second relay is an L2 U2N relay UE; the behavior of stopping using the third bearer to transmit data of a first radio bearer, and starting using a bearer other than the third bearer to transmit data of the first radio bearer comprises, selecting the second relay as a U2N relay of the first node.

In one subembodiment of the embodiment, a relay associated with the bearer other than the third bearer is a second relay, and the second relay is different from the first relay; the second relay is an L2 U2N relay UE; the behavior of stopping using the third bearer to transmit data of a first radio bearer, and starting using a bearer other than the third bearer to transmit data of the first radio bearer comprises, stopping using the first relay.

In one subembodiment of the embodiment, a relay associated with the bearer other than the third bearer is a second relay, and the second relay is different from the first relay; the second relay is an L2 U2N relay UE; the behavior of stopping using the third bearer to transmit data of a first radio bearer, and starting using a bearer other than the third bearer to transmit data of the first radio bearer comprises, assuming that the second relay is a destination L2 U2N relay UE.

In one subembodiment of the embodiment, the bearer other than the third bearer is the second bearer.

### Embodiment 12

Embodiment 12 illustrates a schematic diagram of a third signaling being used to indicate a path switch for a target bearer according to one embodiment of the present application, as shown in FIG. 12.

In one embodiment, the third signaling is used to indicate a path switch for the target bearer;

herein, the first operation set comprises: executing the third signaling; a reception of the third signaling is earlier than the behavior of detecting the target bearer failure.

In one embodiment, the target bearer is the second bearer.

In one embodiment, the target bearer is the first bearer.

In one embodiment, the target bearer is a direct path.

In one embodiment, the target bearer is an indirect path.

In one embodiment, the third signaling indicates a condition-based path switch.

In one subembodiment of the above embodiment, when a condition associated with the path switch is satisfied, the first node executes the path switch.

In one subembodiment of the above embodiment, a condition associated with the path switch comprises that a measurement result of a destination relay of the path switch is greater than a certain threshold.

In one subembodiment of the above embodiment, a condition associated with the path switch comprises that a measurement result of a destination cell of the path switch is greater than a certain threshold.

In one subembodiment of the above embodiment, a condition associated with the path switch comprises that a measurement result of the target bearer is less than a certain threshold.

In one subembodiment of the above embodiment, a condition associated with the path switch comprises detecting the target bearer failure.

In one embodiment, the target bearer is the first bearer, and the third signaling is used to indicate switching from a direct path to an indirect path.

In one embodiment, the target bearer is the second bearer, and the third signaling is used to indicate switching from a direct path to an indirect path.

In one embodiment, the target bearer is the first bearer, and the third signaling is used to indicate switching from an indirect path to a direct path.

In one embodiment, the third signaling indicates executing a transition from a direct path to an indirect path for the target bearer.

In one embodiment, the meaning of the phrase of a path switch for a target bearer comprises: stopping using the target bearer to transmit data for the first cell group.

In one embodiment, the meaning of the phrase of a path switch for a target bearer comprises: releasing the target bearer.

In one embodiment, the meaning of the phrase of a path switch for a target bearer comprises: releasing an RLC entity associated with the target bearer.

In one embodiment, the meaning of the phrase of a path switch for a target bearer comprises: suspending the target bearer.

In one subembodiment of the above embodiment, the target bearer is the first bearer.

In one subembodiment of the above embodiment, the behavior of executing a transition from a direct path to an indirect path comprises switching the target bearer to the second bearer.

In one embodiment, the third signaling comprises parameters of a path switch for the target bearer.

In one embodiment, the third signaling explicitly indicates a path switch for the target bearer.

In one embodiment, a sl-PathSwitchConfig field comprised in the third signaling is used to indicate a path switch for the target bearer.

In one embodiment, the third signaling indicates switching the target bearer to the second bearer.

In one subembodiment of the embodiment, the behavior of the third signaling indicating switching the target bearer to the second bearer comprises: starting using the second bearer, and stopping using the target bearer.

In one subembodiment of the embodiment, the behavior of the third signaling indicating switching the target bearer to the second bearer comprises: activating using the second bearer, and deactivating using the target bearer.

In one subembodiment of the embodiment, the behavior of the third signaling indicating switching the target bearer to the second bearer comprises: continuing the second bearer, and suspending using the target bearer.

In one embodiment, the third signaling comprises an identity of a destination L2 U2N relay UE.

In one subembodiment of the embodiment, the destination L2 U2N relay UE is an L2 U2N relay UE other than the first relay.

In one subembodiment of the embodiment, the destination L2 U2N relay UE is the first relay.

In one embodiment, a sidelink RLC bearer configuration comprised in the third signaling is used for a path switch for the target bearer.

In one subembodiment of the embodiment, the sidelink RLC bearer configuration comprised in the third signaling is a sidelink RLC bearer configuration other than the target bearer.

In one subembodiment of the embodiment, the sidelink RLC bearer configuration comprised in the third signaling is a sidelink RLC bearer configuration other than a sidelink RLC bearer associated with the target bearer.

In one subembodiment of the embodiment, the sidelink RLC bearer configuration comprised in the third signaling is a sidelink RLC bearer configuration associated with the second bearer.

In one subembodiment of the embodiment, the sidelink RLC bearer configuration comprised in the third signaling is or comprises configuration parameters of an RLC entity corresponding to the sidelink RLC bearer comprised in the third signaling.

In one embodiment, the target bearer is an indirect path.

In one embodiment, the meaning of the phrase of a path switch for a target bearer comprises: switching a path associated with the target bearer.

In one embodiment, the meaning of the phrase of a path switch for a target bearer comprises: path switch is related to the target bearer.

In one embodiment, the meaning of the phrase of a path switch for a target bearer comprises: path switch comprises executing at least one operation in a third operation set for the target bearer; the third operation set comprises stopping, suspending, de-activating, and releasing.

In one embodiment, the meaning of the phrase of a path switch for a target bearer comprises: path switch comprises switching the target bearer to another bearer, and the another bearer also belongs to an indirect path.

In one embodiment, the meaning of the phrase of a path switch for a target bearer comprises: executing a transition from a direct path to an indirect path.

In one embodiment, the meaning of the phrase of a path switch for a target bearer comprises: executing a transition from an indirect path to a direct path.

In one embodiment, the meaning of the phrase of a path switch for a target bearer comprises: executing a transition from an indirect path to an indirect path.

In one embodiment, the meaning of the phrase of a path switch for a target bearer comprises: stopping using the target bearer to transmit data for the first cell group, and starting using a bearer other than the target bearer to transmit data for the first cell group.

In one subembodiment of the embodiment, the bearer other than the target bearer is the second bearer.

In one subembodiment of the embodiment, the bearer other than the target bearer is the third bearer.

In one subembodiment of the embodiment, the bearer other than the target bearer is the fourth bearer.

In one subembodiment of the embodiment, the bearer other than the target bearer is a sidelink radio link.

In one subembodiment of the embodiment, the bearer other than the target bearer is a sidelink RLC bearer.

In one subembodiment of the embodiment, the bearer other than the target bearer is a sidelink channel.

In one subembodiment of the embodiment, the bearer other than the target bearer is a direct link.

In one subembodiment of the embodiment, the behavior of stopping using the target bearer comprises releasing the target bearer.

In one subembodiment of the embodiment, the behavior of stopping using the target bearer comprises suspending the target bearer.

In one subembodiment of the embodiment, the behavior of stopping using the target bearer comprises deactivating the target bearer.

In one subembodiment of the embodiment, the behavior of releasing using the target bearer comprises removing a mapping relation between the target bearer and the first cell group or a radio bearer of the first cell group.

In one subembodiment of the embodiment, a relay associated with the bearer other than the target bearer is a second relay, and the second relay is different from the first relay; the second relay is an L2 U2N relay UE; the behavior of stopping using the target bearer to transmit data for the first cell group, and starting using a bearer other than the target bearer to transmit data for the first cell group comprises, selecting the second relay as a U2N relay of the first node.

In one subembodiment of the embodiment, a relay associated with the bearer other than the target bearer is a second relay, and the second relay is different from the first relay; the second relay is an L2 U2N relay UE; the behavior of stopping using the target bearer to transmit data for the first cell group, and starting using a bearer other than the target bearer to transmit data for the first cell group comprises, stopping using the first relay.

In one subembodiment of the embodiment, a relay associated with the bearer other than the target bearer is a second relay, and the second relay is different from the first relay; the second relay is an L2 U2N relay UE; the behavior of stopping using the target bearer to transmit data for the first cell group, and starting using a bearer other than the target bearer to transmit data for the first cell group comprises, assuming that the second relay is a destination L2 U2N relay UE.

In one subembodiment of the embodiment, the bearer other than the target bearer is the second bearer.

In one embodiment, the meaning of the phrase of a path switch for a target bearer comprises: stopping using the target bearer to transmit data for the first cell group, and starting using a bearer other than the target bearer to transmit data for the first cell group.

In one subembodiment of the embodiment, the bearer other than the target bearer is the second bearer.

In one subembodiment of the embodiment, the bearer other than the target bearer is the third bearer.

In one subembodiment of the embodiment, the bearer other than the target bearer is the fourth bearer.

In one subembodiment of the embodiment, the bearer other than the target bearer is a sidelink radio link.

In one subembodiment of the embodiment, the bearer other than the target bearer is a sidelink RLC bearer.

In one subembodiment of the embodiment, the bearer other than the target bearer is a sidelink channel.

In one subembodiment of the embodiment, the bearer other than the target bearer is a direct link.

In one subembodiment of the embodiment, the bearer other than the target bearer is the second bearer.

In one embodiment, the meaning of the phrase of a path switch for a target bearer comprises: stopping using the target bearer to transmit data of a first radio bearer, and starting using a bearer other than the target bearer to transmit data of the first radio bearer.

In one subembodiment of the embodiment, the bearer other than the target bearer is a sidelink radio link.

In one subembodiment of the embodiment, the bearer other than the target bearer is a sidelink RLC bearer.

In one subembodiment of the embodiment, the bearer other than the target bearer is a sidelink channel.

In one subembodiment of the embodiment, the bearer other than the target bearer is a direct link.

In one subembodiment of the embodiment, the first radio bearer is a radio bearer.

In one subembodiment of the embodiment, the first radio bearer is or comprises SRB1.

In one subembodiment of the embodiment, the first radio bearer is or comprises a DRB.

In one subembodiment of the embodiment, the first radio bearer is or comprises an MRB.

In one subembodiment of the embodiment, the behavior of stopping using the target bearer to transmit data of a first radio bearer comprises releasing the target bearer.

In one subembodiment of the embodiment, the behavior of stopping using the target bearer to transmit data of a first radio bearer comprises suspending the target bearer.

In one subembodiment of the embodiment, the behavior of stopping using the target bearer to transmit data of a first radio bearer comprises deactivating the target bearer.

In one subembodiment of the embodiment, the behavior of stopping using the target bearer to transmit data of a first radio bearer comprises releasing a mapping relation between the target bearer and the first radio bearer.

In one subembodiment of the embodiment, the behavior of starting using a bearer other than the target bearer to transmit data of the first radio bearer comprises: activating the bearer other than the target bearer.

In one subembodiment of the embodiment, the behavior of starting using a bearer other than the target bearer to transmit data of the first radio bearer comprises: establishing a mapping relation between the bearer other the target bearer and the first radio bearer.

In one subembodiment of the embodiment, a relay associated with the bearer other than the target bearer is a second relay, and the second relay is different from the first relay; the second relay is an L2 U2N relay UE; the behavior of stopping using the target bearer to transmit data of a first radio bearer, and starting using a bearer other than the target bearer to transmit data of the first radio bearer comprises, selecting the second relay as a U2N relay of the first node.

In one subembodiment of the embodiment, a relay associated with the bearer other than the target bearer is a second relay, and the second relay is different from the first relay; the second relay is an L2 U2N relay UE; the behavior of stopping using the target bearer to transmit data of a first radio bearer, and starting using a bearer other than the target bearer to transmit data of the first radio bearer comprises, stopping using the first relay.

In one subembodiment of the embodiment, a relay associated with the bearer other than the target bearer is a second relay, and the second relay is different from the first relay; the second relay is an L2 U2N relay UE; the behavior of stopping using the target bearer to transmit data of a first radio bearer, and starting using a bearer other than the target bearer to transmit data of the first radio bearer comprises, assuming that the second relay is a destination L2 U2N relay UE.

In one subembodiment of the embodiment, the bearer other than the target bearer is the second bearer.

### Embodiment 13

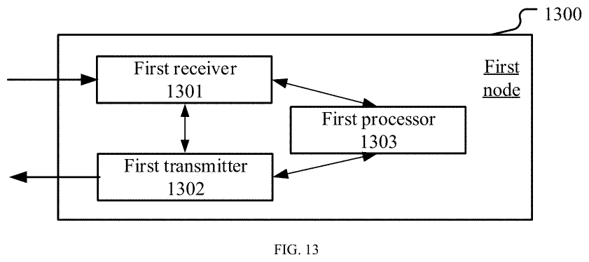

Embodiment 13 illustrates a structure block diagram of a processor in a first node according to one embodiment of the present application, as shown in FIG. 13. In FIG. 13, a processor 1300 in a first node comprises a first receiver 1301, a first transmitter 1302 and the first processor 1303. In Embodiment 13,

the first receiver 1301, receives a first signaling, the first signaling is used to configure a first bearer and a second bearer, both the first bearer and the second bearer are associated with a first cell group; the first cell group is an MCG; and detects a target bearer failure;

the first processor 1303, as a response to the behavior of detecting a target bearer failure, executes a first operation set; the first operation set is related to whether the target bearer is the first bearer or the second bearer.

herein, the second bearer is associated with a first relay, and the first relay is an L2 U2N relay UE; the meaning of the phrase of the first operation set being related to whether the target bearer is the first bearer or the second bearer is: when the target bearer is the first bearer, the first operation set comprises at least a former of transmitting an RRC message and receiving an RRC message, and the first operation set comprises at least one of cell selection or relay selection; when the target bearer is the second bearer, the first operation set comprises transmitting first information, and the first information is used to indicate the target bearer failure.

In one embodiment, SRB1 of the first node is only associated with the first bearer in the first bearer and the second bearer.

In one embodiment, SRB1 of the first node is associated with the first bearer and the second bearer at the same time.

In one embodiment, the first operation set comprises: releasing the second bearer, suspending SRB1 associated with the target bearer; the first operation set comprises: executing any of cell selection and relay selection;

herein, the first operation set comprises transmitting an RRC re-establishment request message.

In one embodiment, the first operation set comprises: executing at least one operation in a second operation set only for a former of the first bearer and the second bearer;

herein, the second operation set comprises suspending, re-establishing, and releasing.

In one embodiment, whether the first operation set comprises initiating a random access is related to whether the target bearer is the first bearer or the second bearer; when the target bearer is the first bearer, the first operation set comprises initiating a random access procedure; when the target bearer is the second bearer, the first operation set does not comprise initiating a random access procedure.

In one embodiment, the first receiver 1301 receives a second signaling, as a response to receiving the second signaling, starts a first timer;

herein, when the behavior of detecting that a target bearer failure is executed, the first timer is running; the second signaling comprises a first field, the first field is reconfigurationWithSync, the first field is used to indicate a path switch for the second bearer, and the target bearer is the first bearer; the first timer is a timer other than T304.

In one embodiment, the first receiver 1301, as a response to receiving a second sub-signaling, starts a first timer, suspends a third bearer, and configures the second bearer;

herein, the first operation set comprises: activating the third bearer; the first operation set comprises at least one of suspending the second bearer, releasing the second bearer or re-establishing the second bearer; the first signaling comprises a first sub-signaling, the second sub-signaling and a third sub-signaling, the first sub-signaling is used to configure the first bearer, the third sub-signaling is used to configure the third bearer, and the second sub-signaling is used to configure the second bearer; the third bearer is associated with a second relay, the second relay is an L2 U2N relay UE, the first relay is different from the second relay, and the third bearer is associated with the first cell group; the target bearer is the second bearer; the second sub-signaling comprises a first field, the first field is reconfigurationWithSync, the first field is used to indicate a path switch for the third bearer, and the first timer is a timer other than T304; the behavior of detecting a target bearer failure comprises detecting an expiration of the first timer.

In one embodiment, the first receiver 1301 receives a third signaling, and the third signaling is used to indicate a path switch for the target bearer;

herein, the first operation set comprises: executing the third signaling; a reception of the third signaling is earlier than the behavior of detecting the target bearer failure.

In one embodiment, the first receiver 1301 receives a fourth signaling, and the fourth signaling is used to configure a fourth bearer; the behavior of configuring the fourth bearer comprises setting the fourth bearer as a deactivated state;

herein, the first operation set comprises: activating the fourth bearer; the first operation set comprises: at least one of suspending the second bearer, deactivating the second bearer or releasing the second bearer; the target bearer is the second bearer.

In one embodiment, the first node is a UE.

In one embodiment, the first node is a terminal that supports large delay differences.

In one embodiment, the first node is a terminal that supports NTN.

In one embodiment, the first node is an aircraft or vessel.

In one embodiment, the first node is a mobile phone or vehicle terminal.

In one embodiment, the first node is a relay UE and/or U2N remote UE.

In one embodiment, the first node is an Internet of Things terminal or an Industrial Internet of Things terminal.

In one embodiment, the first node is a device that supports transmission with low-latency and high-reliability.

In one embodiment, the first node is a sidelink communication node.

In one embodiment, the first receiver 1301 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1302 comprises at least one of the antenna 452, the transmitter 454, the transmitting processor 468, the multi-antenna transmitting processor 457, the controller/processor 459, the memory 460 or the data source 467 in Embodiment 4.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things, RFID terminals, NB-IOT terminals, Machine Type Communication (MTC) terminals, enhanced MTC (eMTC) terminals, data cards, low-cost mobile phones, low-cost tablet computers, satellite communication equipment, vessel communication equipment, NTN UEs, etc. The base station or system device in the present application includes but is not limited to macro-cellular base stations, micro-cellular base stations, home base stations, relay base station, gNB (NR node B), Transmitter Receiver Point (TRP), NTN base stations, satellite equipment, flight platform equipment and other radio communication equipment.

This application can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first signaling, the first signaling being used to configure a first bearer and a second bearer, both the first bearer and the second bearer being associated with a first cell group; the first cell group is a Master Cell Group (MCG); detecting a target bearer failure; and
a first processor, as a response to the behavior of detecting a target bearer failure, executing a first operation set;
the first operation set is related to whether the target bearer is the first bearer or the second bearer;
wherein the second bearer is associated with a first relay, and the first relay is a Layer-2 UE to Network (L2 U2N) relay User Equipment (UE); the meaning of the phrase of the first operation set being related to whether the target bearer is the first bearer or the second bearer is: when the target bearer is the first bearer, the first operation set comprises at least a former of transmitting an Radio Resource Control (RRC) message and receiving an RRC message, and the first operation set comprises at least one of cell selection or relay selection;
when the target bearer is the second bearer, the first operation set comprises transmitting first information, and the first information is used to indicate the target bearer failure.

2. The first node according to claim 1, wherein Signaling Radio Bearer 1 (SRB1) of the first node is only associated with the first bearer in the first bearer and the second bearer.

3. The first node according to claim 1, wherein SRB1 of the first node is associated with the first bearer and the second bearer at the same time.

4. The first node according to claim 1, wherein the first operation set comprises: releasing the second bearer, suspending SRB1 associated with the target bearer; the first operation set comprises: executing any of cell selection and relay selection;
wherein the first operation set comprises transmitting an RRC re-establishment request message; the target bearer is the first bearer.

5. The first node according to claim 2, wherein the first operation set comprises: releasing the second bearer, suspending SRB1 associated with the target bearer; the first operation set comprises: executing any of cell selection and relay selection;
wherein the first operation set comprises transmitting an RRC re-establishment request message; the target bearer is the first bearer.

6. The first node according to claim 1, wherein the first operation set comprises: executing at least one operation in a second operation set only for a former of the first bearer and the second bearer;
wherein the second operation set comprises suspending, re-establishing, and releasing; the target bearer is the first bearer.

7. The first node according to claim 5, wherein the first operation set comprises: executing at least one operation in a second operation set only for a former of the first bearer and the second bearer;
wherein the second operation set comprises suspending, re-establishing, and releasing; the target bearer is the first bearer.

8. The first node according to claim 1, wherein whether the first operation set comprises initiating a random access is related to whether the target bearer is the first bearer or the second bearer; when the target bearer is the first bearer, the first operation set comprises initiating a random access procedure; when the target bearer is the second bearer, the first operation set does not comprise initiating a random access procedure.

9. The first node according to claim 5, wherein whether the first operation set comprises initiating a random access is related to whether the target bearer is the first bearer or the second bearer; when the target bearer is the first bearer, the first operation set comprises initiating a random access procedure; when the target bearer is the second bearer, the first operation set does not comprise initiating a random access procedure.

10. The first node according to claim 7, wherein whether the first operation set comprises initiating a random access is related to whether the target bearer is the first bearer or the second bearer; when the target bearer is the first bearer, the first operation set comprises initiating a random access procedure; when the target bearer is the second bearer, the first operation set does not comprise initiating a random access procedure.

11. The first node according to claim 1, comprising:
the first receiver, receiving a second signaling, as a response to receiving the second signaling, starting a first timer;
wherein when the behavior of detecting that a target bearer failure is executed, the first timer is running; the second signaling comprises a first field, the first field is reconfigurationWithSync, the first field is used to indicate a path switch for the second bearer, and the target bearer is the first bearer; the first timer is a timer other than T304.

12. The first node according to claim 3, comprising:
the first receiver, receiving a second signaling, as a response to receiving the second signaling, starting a first timer;
wherein when the behavior of detecting that a target bearer failure is executed, the first timer is running; the second signaling comprises a first field, the first field is reconfigurationWithSync, the first field is used to indicate a path switch for the second bearer, and the target bearer is the first bearer; the first timer is a timer other than T304.

13. The first node according to claim 1, comprising:
the first receiver, as a response to receiving a second sub-signaling, starting a first timer, suspending a third bearer, and configuring the second bearer;
wherein the first operation set comprises: activating the third bearer; the first operation set comprises at least one of suspending the second bearer, releasing the second bearer or re-establishing the second bearer; the first signaling comprises a first sub-signaling, the second sub-signaling and a third sub-signaling, the first sub-signaling is used to configure the first bearer, the third sub-signaling is used to configure the third bearer, and the second sub-signaling is used to configure the second bearer; the third bearer is associated with a second relay, the second relay is an L2 U2N relay UE, the first relay is different from the second relay, and the third bearer is associated with the first cell group; the target bearer is the second bearer; the second sub-signaling comprises a first field, the first field is reconfigurationWithSync, the first field is used to indicate a path switch for the third bearer, and the first timer is a timer other than T304; the behavior of detecting a target bearer failure comprises detecting an expiration of the first timer.

14. The first node according to claim 1, comprising:
the first receiver, receiving a third signaling, and the third signaling being used to indicate a path switch for the target bearer;
wherein the first operation set comprises: executing the third signaling; a reception of the third signaling is earlier than the behavior of detecting the target bearer failure; the target bearer is the first bearer; the third signaling is used to indicate switching from a direct path to an indirect path.

15. The first node according to claim 1, comprising:
the first receiver, receiving a fourth signaling, the fourth signaling being used to configure a fourth bearer; the behavior of configuring the fourth bearer comprises setting the fourth bearer as a deactivated state;
wherein the first operation set comprises: activating the fourth bearer; the first operation set comprises: at least one of suspending the second bearer, deactivating the second bearer or releasing the second bearer; the target bearer is the second bearer.

16. The first node according to claim 1, wherein the first bearer is a direct path; the second bearer is an indirect path.

17. The first node according to claim 2, wherein the first bearer is a direct path; the second bearer is an indirect path.

18. The first node according to claim 5, wherein the first bearer is a direct path; the second bearer is an indirect path.

19. The first node according to claim 8, wherein the first bearer is a direct path; the second bearer is an indirect path.

20. A method in a first node for wireless communications, comprising:
receiving a first signaling, the first signaling being used to configure a first bearer and a second bearer, both the first bearer and the second bearer being associated with a first cell group; the first cell group is an MCG; detecting a target bearer failure; and
as a response to the behavior of detecting a target bearer failure, executing a first operation set; the first operation set is related to whether the target bearer is the first bearer or the second bearer;
wherein the second bearer is associated with a first relay, and the first relay is an L2 U2N relay UE; the meaning of the phrase of the first operation set being related to whether the target bearer is the first bearer or the second bearer is: when the target bearer is the first bearer, the first operation set comprises at least a former of transmitting an RRC message and receiving an RRC message, and the first operation set comprises at least one of cell selection or relay selection; when the target bearer is the second bearer, the first operation set comprises transmitting first information, and the first information is used to indicate the target bearer failure.
